(19) United States
(12) Patent Application Publication
(10) Pub. No.: US 2007/0021300 A1
(43) Pub. Date: Jan. 25, 2007

(54) Process for the production of activated carbon

(76) Inventor: Jean-Pierre Farant, Cantley (CA)

Correspondence Address: Timothy E Nauman;Fay Sharpe Fgan Minnich & McKee, 7th Floor, 1100 Superior Avenue, Cleveland, OH, 44114, US

(21) Appl. No.: 10/555,555

(22) PCT Filed: May 10, 2004
(86) PCT No.: PCT/CA04/00703

§ 371 Date: Nov. 4, 2005

Related U.S. Application Data
(60) Provisional application No. 60/469,019, filed on May 9, 2003.

(51) Int. Cl. C01B 31/08

(52) U.S. Cl. 502/430

(57) ABSTRACT

The present invention relates processes for the preparation of activated carbon materials; the present invention also relates activated carbon materials and in particular to materials comprising activated carbon fibers such as for example fabric or fabric like materials of activated carbon fibers. These materials may be used as adsorbents to take up predetermined components from a fluid (e.g. undesirable organic compounds from air).

The present invention relates processes for the preparation of activated carbon materials; the present invention also relates to activated carbon materials and in particular to materials comprising activated carbon fibers such as for example fabric or fabric like materials of activated carbon fibers. These materials may be used as adsorbents to take up predetermined components from a fluid (e.g. undesirable organic compounds from air).

Activated carbon is a term used to designate carbonaceous adsorbents having an extensively developed internal pore structure. In accordance with IUPAC for example it is understood that pores may be divided into a number of groups, namely,

macropores: are pores larger than 500 angstroms

mesopores: are pores of 20 to 500 angstroms

micropore: are pores of less than 20 angstroms.

The degree of adsorption with respect to activated carbon materials depends, inter alia, on the pore size, number and distribution (i.e. among the above mentioned groups).

Activated carbon is widely used today as an essential component of filtration systems in industry and elsewhere for the removal of relatively low concentrations of volatile organic contaminants from air streams. Currently, the demand for this material is estimated at 220,000 metric tons per year and increasing at the rate of 5.4% per annum due, in parts, to increases in the output of chemical processes and more stringent environmental regulations worldwide. In addition, the occupants of office buildings, the residents of private homes and institutions, the passengers in commercial aircraft, trains and vehicles are increasingly concerned about the quality of the air they breathe. These concerns have become more acute with the implementation of energy conservation measures in these microenvironments and the increasing usage of synthetic materials for construction. This has invariably led to the design of air treatment systems which incorporate components based on the use of activated carbon for the control of gaseous organic pollutants.

It is known to exploit activated carbon in granular, powdered or bulk format for the adsorption of unwanted components or contaminants of a fluid such as, for example, air or water.

Most of the activated carbon used today for the removal of low concentrations of gaseous contaminants from air streams is either granulated or pelletized carbon usually placed in trays or incorporated in a matrix or bonded to fiber and shaped into panels or blocks (see for example WO 94/03270; PCT/US93/06274). The contaminated air stream is channeled through a bed of activated carbon which adsorbs the gaseous contaminants. Inherent problems associated with such systems include very high pressure drops and the periodic replacement of large quantities of highly contaminated carbon and either its regeneration off-site or its disposal in designated landfills. This process is labor intensive, potentially hazardous and very costly.

It is also known that it is advantageous to have activated carbon in fibrous format such as a cloth in order to be able to promote a low pressure drop across a system in which such cloth is disposed for adsorption.

Activated carbon cloth, woven or knitted or as a felt can be used to prepare relatively thin carbon beds which have low pressure drop, rapid kinetics and an adsorptive capacity which rivals that of granular carbon. Although it is ideally suited for air purification applications, it must also be periodically replaced and the time between replacements can be relatively short. A recent development which allows for the electrothermal reactivation of spent carbon materials (see, for example, U.S. Pat. No. 5,827,355) effectively circumvents these difficulties and leaves open the way for the exploitation of electrically conductive carbon cloth as a markedly superior alternative to all prior art in this field.

It is further known that the process for the activation of fibrous like carbon containing materials normally removes a relatively large portion of the starting material (i.e. high burn off) with attendant loss in strength as well as flexibility, i.e. processes are known which provide relatively low yield (see U.S. Pat. No. 5,202,302).

It is known to exploit an activation process involving treatment of carbon sources, chemically (usually with phosphoric acid or other similarly acting acid like materials) under thermal conditions i.e. heat treatment. U.S. Pat. No. 5,202,302 describes the use of boron compounds in addition to phosphorous compounds.

One of the most relevant and obstinate barriers to the attainment of an optimally performing activated carbon (granular, cloth or powder) tailored to a specific need is a better definition and control of its pore structure and the characteristics of the interrelationship between chemical change and the development of extensive pore structures during activated carbon synthesis. The resolution of these longstanding problems would effectively enhance the utilization of activated carbon in most technologies involving adsorptive processes.

It would be advantageous to be able to have a process able to allow for the preparation of activated carbon having a relatively high adsorption capacity (e.g. for organic substances. such as organic vapours or gases), an optimizable pore size distribution, an optimal tensile strength, and in good yield in a relatively short period of time. It would in particular be advantageous to be able to derive activated carbon from textile or textile like materials, whether woven or non-woven including felt like materials; e.g. textile or textile like materials (e.g. materials such as for example cloth, felts, etc) based on cellulosic material, or cellulosic like carbohydrate or polysaccharide, material, etc.

It would be advantageous to have a process for the manufacture of a fibrous material which would tend to give high yields which approach theoretical yields.

The surface area of an activated carbon is directly related to the carbon's porosity; the adsorption capacity of an activated carbon may be enhanced by increasing its volume of micropores (less than 20-25 angstroms and more than 8-10 angstroms. in size or width), as a percentage of total pore volume. It would be advantageous to have activation methods which are pore size specific. In particular, able to provide activated carbon with relatively high pore populations having pores in the size range above 8 to 10 angstroms and as well in the size range above 20 angstroms (e.g. from about 25 to 50 angstroms).

It would for example in particular be advantageous to have a method able to provide for the (cost) effective preparation of a cellulose-based (e.g. textile) activated carbon in high yield with a desired density and a relatively high BET (e.g. surface area>2200 m²/gram and having a pore size distribution which may be customized to its anticipated applications for the removal of gaseous organic contaminants in air streams; BET—Brunauer,Emmet,Teller index of surface area for porous substances. For example it would be advantageous if an aforementioned activated textile or textile like material (e.g. carbon cloth) may be susceptible to electrothermal regeneration of the textile material (e.g. carbon cloth), the textile material (e.g. carbon cloth) having an electrical conductivity that may facilitate such a process.

It would for example be advantageous to have activated carbon derived from cellulosic material (e.g. in fibrous format), wherein 45% or more (e.g. at least 80%) of the pore volume is attribuable to pores whose pore size is equal to or greater than 8 to 10 Angstroms. It would be advantageous to have an activated carbon derived from cellulosic material of relatively high adsorption capacity on a gram per gram (g/g) basis. It would for example be advantageous to have an activated carbon derived from cellulosic material (e.g. in fibrous format) of relatively high tensile strength. It would be further advantageous to have a means for obtaining an activated carbon product in yields approaching theoretical values. It would also be further advantageous to have a high-specific-surface area product. It would further be advantageous to have an activated carbon material of a relatively high (bulk) density relative to the initial starting material, e.g. a bulk density which may be equal to or greater than 45% (e.g. 75%) of the initial precursor bulk density.

It would be advantageous to have an activated carbon material having a relatively low resistivity for the electrothermal reactivation of spent activated carbon materials.

It would be advantageous to have activated carbon material which once loaded (i.e. with an organic material) may be susceptible to regeneration, e.g. by suitable (known) thermal treatment. It is to be understood herein that the entire contents of any and all patents, applications and the like mentioned herein are incorporated herein by reference.

### STATEMENT OF INVENTION

Thus the present invention in one aspect provides a process for the preparation of a dehydrated carbon precursor material from a starting carbon precursor material, comprising subjecting said starting carbon precursor material to a dehydration stage whereby water is eliminated from the structure of the starting carbon precursor material (i.e. from the chemical structure thereof),

wherein

the dehydration stage comprises
   a dehydration heating step comprising heating the starting carbon precursor material, in the presence of a dehydration stage treatment agent, at a dehydration temperature below 220° C. (e.g. a dehydration temperature of 200° C. or less) for a time period sufficient so as to obtain a dehydrated carbon precursor material.
      In accordance with the present invention the starting carbon precursor material may be a cellulosic material as described herein. Thus for example the starting carbon precursor material may be derived from a fibrous cellulosic material; the starting carbon precursor material may be a cellulosic material associated with a non-reactive material stable at said dehydration temperature; the starting carbon precursor material may be a material selected from the group consisting of woven and non-woven cellulosic materials; and the like. The dehydration heating may, for example, be effected at a temperature in the range of from 120° C. to 200° C.; at a temperature in the range of from 140° C. to 200° C.; at a temperature in the range of from 150° C. to 200° C.; at a temperature in the range of above 150° C. to 200° C.; at a temperature in the range of from 151° C. to 200° C.; etc. The dehydration stage treatment agent may, for example, be a polar solvent soluble phosphorous containing inorganic lewis acid compound. The dehydration stage treatment agent may for example, in particular be selected from the group consisting of phosphoric acid, polyphosphoric acid, pyrophosphoric acid, metaphosphoric acid and mixtures thereof. The various elements of the dehydration stage will be described in more detail below.

The removal of H and O may for example be detected in the H₂O_{(g)} form in the off-gas by the use of a Fourier-Transform Infrared Spectrometer (FTIR).
In accordance with the present invention the dehydration stage may comprise prior to said dehydration heating step a impregnation step and subsequent to said dehydration heating step if desired or necessary a polar solvent washing step
   said impregnation step may comprise incorporating a polar solvent soluble acidic dehydration stage treatment agent via a low boiling point fluid carrier vehicle into a starting carbon precursor material so as to obtain a starting carbon precursor material impregnated with a dehydration stage treatment agent, said impregnation step including a fluid carrier removal step comprising driving off the low boiling point fluid carrier so as to obtain a dehydration stage treatment agent impregnated starting carbon precursor material at least essentially free of said fluid carrier, said low boiling point being below that of water at a standard pressure and temperature of 1 atmosphere and 15° C.,
   said polar solvent washing step may comprise washing dehydration stage treatment agent (as well as any by-product materials associated with said dehydrated carbon precursor material) from said dehydrated carbon recursor material.
      The above impregnation and washing steps, as desired or necessary, may also be used in relation to the other heat treatment stages described herein.
The present invention in accordance with another aspect provides a process for the preparation of an activated carbon product, comprising subjecting a starting carbon precursor material to a dehydration stage, whereby water is eliminated from the structure of the starting carbon precursor material (i.e. from the chemical structure thereof), followed by an activation stage,
   wherein
   the dehydration stage comprises
      a dehydration heating step comprising heating the starting carbon precursor material, in the presence of a dehydration stage treatment agent, at a dehydration temperature below 220° C. (e.g. a dehydration temperature of 200° C. or less) for a time period sufficient so as to obtain a dehydrated carbon precursor material and
   an activation stage comprising
      a subsequent activation heating step comprising heating obtained dehydrated carbon precursor material in the presence of an oxidation-suppressing atmosphere, in the presence of a activation stage treatment agent at a temperature higher than 650° C. (e.g. at a temperature higher than 700° C.) for a time period sufficient so as to obtain an activated carbon product.
         The various elements of the dehydration stage may be as described above as well as herein below. The subsequent heating step may, for example, be effected at a temperature in the range of from 700° C. to 1200° C.; at a temperature in the range of from 700° C. to 1000° C.; at a temperature in the range of from 750° C. to 950° C.; etc. The activation stage treatment agent may be selected from the group consisting of polar solvent soluble phosphorous containing inorganic compounds, polar solvent soluble boron containing acidic compounds, and mixtures thereof. The activation stage treatment agent may, for example, independently take the form of a material as described with respect to the dehydration stage treatment agent or another agent material (including mixtures) as described herein (e.g. polar solvent soluble boron containing acidic (i.e. inorganic) compounds as well as mixtures with phosphorous compounds).

It is to be understood that an oxidation suppressing atmosphere or environment is one which is unreactive or essentially unreactive under the process conditions described herein. (e.g. an atmosphere such as an inert gas such as for example, nitrogen, helium or argon); it does not include atmospheres derived from steam or CO₂. If so desired any one of the heat treatment stages described herein can be carried out in an oxidation suppressing atmosphere or environment.

The present invention in accordance an additional aspect provides a process for the preparation of an activated carbonized material, comprising subjecting a starting dehydrated carbon precursor material to a carbonization stage whereby carbon (C) is lost from the structure of the starting dehydrated carbon precursor material (i.e. from the chemical structure thereof), wherein
the carbonization stage comprises
   a carbonization heating step comprising heating the starting dehydrated carbon precursor material, in the presence of a carbonization stage treatment agent, at a carbonization temperature below 450° C. (e.g. a carbonization temperature of up to 400° C.) for a time period sufficient so as to obtain an activated carbonized material.
      In accordance with the present invention the starting dehydrated carbon precursor material may be derived from a cellulosic material as discussed, above with respect to the dehydration stage as well as herein below. The carbonization heating step may, for example, be effected at a temperature in the range of from 220° C. to 400° C.; at a temperature in the range of from 250° C. to 400° C.; etc. The carbonization stage treatment agent may, for example, independently take the form of a material as described with respect to the activation stage treatment agent as described above as well as herein below; thus carbonization stage treatment agent and said activation stage treatment agent may each be independently selected from the group consisting of polar solvent soluble phosphorous containing acidic (i.e. inorganic) compounds, polar solvent soluble boron containing acidic (i.e. inorganic) compounds, and mixtures thereof.

As mentioned above, the carbonization process involves carbon removal from a structure (e.g. elimination of oxides of carbon such CO₂ and possibly CO. The removal of carbon may for example be detected in the CO_{(g)} or CO₂ form in the off-gas by the use of a Fourier-Transform Infrared Spectrometer (FTIR).

In accordance with the present invention the carbonization stage may comprise prior to said carbonization heating step an impregnation step wherein said starting dehydrated carbon precursor material is associated with (i.e. impregnated with) a carbonization stage treatment agent so as to obtain starting dehydrated carbon material impregnated with carbonization stage treatment agent. Additionally, if so desired or necessary the said carbonization stage may further comprise subsequent to said carbonization heating step a polar solvent washing step wherein carbonization stage treatment agent (as well as by-product materials associated with said activated carbonized material) is/are washed from said activated carbonized material. As noted above the dehydration stage may also comprise an impregnation step and a washing step.

The present invention in accordance with another aspect provides a process for the preparation of an activated carbon product, comprising subjecting a starting dehydrated carbon precursor material to a carbonization stage whereby carbon (C) is lost from the structure of the starting dehydrated carbon precursor material (i.e. from the chemical structure thereof) followed by an activation stage; the carbonization stage and activation stage being as described above as well as herein below.

The present invention in accordance with another aspect provides process for the preparation of an activated carbon product comprising subjecting a starting activated carbonized precursor material to an aromatization stage whereby H is lost from the structure of the starting carbonized precursor material (i.e. from the chemical structure thereof), said starting carbonized precursor material being derived from a cellulosic material,

wherein

the aromatization stage comprises
   an aromatization heating step comprising heating the starting activated carbonized precursor material, in the presence of an oxidation-suppressing atmosphere, in the presence of an aromatization stage treatment agent, at a temperature of up to 650° C. for a time period sufficient so as to obtain an activated carbon product.
      In accordance with the present invention the starting activated carbonized precursor material may be derived from a cellulosic material as discussed, above with respect to the dehydration stage as well as herein below. The carbonization heating step may, for example, be effected at a temperature in the range of from 450° C. to 650° C.; at a temperature in the range of from 500° C. to 650° C.; etc. The aromatization stage treatment agent may, for example, independently take the form of a material as described with respect to the activation stage treatment agent as described above as well as herein below thus aromatization stage treatment agent may each be selected from the group consisting of polar solvent soluble phosphorous containing acidic (i.e. inorganic) compounds, polar solvent soluble boron containing acidic (i.e. inorganic) compounds, and mixtures thereof.

The removal of H may for example be detected in the H_{2(g)} form in the off-gas by the use of a Thermal Conductance Detector (TCD).

In accordance with the present invention the aromatization stage may comprise prior to said aromatization heating step an impregnation step wherein said starting carbonized precursor material is associated with (i.e. impregnated with) an aromatization stage treatment agent so as to obtain starting carbonized material impregnated with aromatization stage treatment agent. In accordance with the present invention the aromatization stage may comprise subsequent to said aromatization heating step a polar solvent washing step wherein aromatization stage treatment agent (as well as by-product materials associated with said activated carbon material) is/are washed from said activated carbon material. In accordance with the present invention the starting carbonized precursor material may be a gas flowthrough porous material and said heating may occur in the presence of an oxidation-suppressing atmosphere comprising an oxidation-suppressing gas, said gas being induced to flow through said carbonized precursor material, and wherein a source of aromatization stage treatment agent is disposed upstream of said carbonized precursor material for introducing volatized aromatization stage treatment agent into said gas flow, said aromatization stage treatment agent having a volatilization temperature below the treatment temperature used for obtaining said activated carbon material.

The present invention in another aspect provides a process for the preparation of an activated carbon product comprising subjecting a starting activated carbonized precursor material to an aromatization stage whereby H is lost from the structure of the starting carbonized precursor material (i.e. from the chemical structure thereof) followed by a reformation stage, said starting carbonized precursor material being derived from a cellulosic material,
wherein
the aromatization stage comprises
   an aromatization heating step comprising heating the starting activated carbonized precursor material, in the presence of an oxidation-suppressing atmosphere, in the presence of an aromatization stage treatment agent, at a temperature of up to 650° C. for a time period sufficient so as to obtain an intermediate activated carbon material,
the reformation stage comprises
   a subsequent heating step comprising heating obtained intermediate activated carbon material in the presence of an oxidation-suppressing atmosphere, in the presence of a reformation stage treatment agent at a temperature higher than 650° C. (e.g. at a temperature higher than 700° C.) for a time period sufficient so as to obtain an activated carbon product.
      The various elements of the aromatization stage may be as described above as well as herein below; similarly the elements of the reformation stage may be as described above with respect to the activation stage as well as herein below.

The present invention in accordance with yet another aspect as may be gleaned from the above provides a process for the modification of a starting carbonaceous precursor material selected from the group consisting of an aromatized activated carbon precursor material and an activated carbonized precursor material, said process comprising heating said starting carbonaceous precursor material, in the presence of an oxidation-suppressing atmosphere, in the presence of an activation treatment agent, at a temperature in the range of from 700° C. or higher for a time period sufficient so as to obtain activated carbon product. The carbonaceous precursor material may be derived from a cellulosic material (i.e. as described herein). The subsequent heating step may, for example, be effected at a temperature in the range of from 700° C. to 1200° C.; at a temperature in the range of from 700° C. to 1000° C.; at a temperature in the range of from 750° C. to 950° C.; etc. The activation stage treatment agent may, for example, independently take the form of a material as described with respect to the dehydration stage treatment agent or another agent material (including mixtures) as described herein (e.g. polar solvent soluble boron containing acidic (i.e. inorganic) compounds). The starting carbonaceous precursor material may be impregnated with an activation treatment agent. The process may as desired or necessary comprise a polar solvent washing step wherein activation treatment agent associated with said activated carbon product is washed from said activated carbon product with a polar solvent.

In accordance with the present invention said starting carbonaceous precursor material may be a gas flowthrough porous material and said subsequent heating may occur in the presence of an oxidation-suppressing atmosphere comprising an oxidation-suppressing gas, said gas being induced to flow through said carbonaceous precursor material, and wherein a source of activation treatment agent is disposed upstream of said carbonaceous precursor material for introducing volatized activation treatment agent into said gas flow, said activation treatment agent having a volatilization temperature below the treatment temperature used for obtaining said activated carbon product.

The present invention in a further aspect provides a process for treatment of a heat treated carbon material associated with a polar solvent soluble activation treating agent comprising subjecting said activated carbon material to a washing step wherein activation treatment agent is washed from said activated carbon material by a polar solvent.
The present invention in another aspect provides a heating system for subjecting a precursor material for the preparation of an active carbon to a heat treatment, said precursor material being disposable as a porous body, said system comprising
   a gas path component having a gas intake side and a gas discharge side and defining a gas flow path;
   a precursor support component for supporting said precursor material transversely across said gas flow path for the passage of gas through said carbon precursor material;
      and
   a heating component for heating a gas to a predetermined heating temperature prior to passage of the gas through precursor material supported by said support component.
      In accordance with the present invention such a system may further comprise a treatment agent source component disposed upstream of said precursor support for introducing volatized treatment agent into said gas flow path.

The present invention further provides an activated carbon material having a resistivity of not more than 1000 Ohms-cm; for example a resistivity of 2-1060 ohms-cm. In accordance with the present invention an activated carbon material may have a resistivity of not more than 550 Ohms-cm, e.g. a resistivity of not more than 100 Ohms-cm. In accordance with another aspect the present invention provides an activated carbon material characterized in that at least 10% of the total pore volume of the activated carbon material may be attributable to pores having a pore size of 20 angstroms or higher. In accordance with the present invention an activated carbon material may be characterized in that at least 12% to 20% or more of the total pore volume of the activated carbon material may be attributable to pores having a pore size of 20 angstroms or higher; e.g. wherein 30% or more of the total pore volume of the activated carbon material may be attributable to pores having a pore size of 20 angstroms or higher. In accordance with the present invention an activated carbon material may be characterized in that at least 45% to 60% (or more) of the total pore volume of the activated carbon material may be attributable to pores having a pore size of 10 angstroms or higher; e.g. 80% (or more) of the total pore volume of the activated carbon material may be attributable to pores having a pore size of 10 angstroms or higher. An activated material in accordance with the present invention may be derived from a cellulosic material as described herein. An activated material in accordance with the present invention may reflect a combination of the above characteristics.

The present invention, as may be gleaned from the above, relates to activated carbon materials as well as their manufacture. The activated carbon material may have a (internal) pore size distribution, BET, Toluene adsorption, butane no. etc. as described herein.

The activated carbon materials of the present invention may be derived from materials having any desired or necessary structural formats. The activated carbon materials of the present invention may, for example, be derived from carbon precursor materials (non-activated or activated) having an initial discrete fibrous or fibrous like structure such that the desired or predetermined activated carbon product has an analogous physical format. Thus a basic carbon precursor material may have a structural format which reflects a fiber, a filament, a yarn, a thread or the like. An initial raw carbon precursor material may furthermore incorporate or be built up from a basic fiber, filament or yarn. An initial carbon precursor material may have a woven structure or a non-woven structure including a felt or mat like structure; e.g. the initial raw precursor material may, by way of example only, take the form of a textile or cloth like material. Alternatively, the present invention, for example, also relates to the conversion of carbon precursor materials, having a physical format of particulate type, into activated carbon forms thereof; by particulate format is meant structures including for example grains, granules, pellets, chips (e.g. wood chips) as well as smaller sized particles etc. The invention further relates to activated carbon materials which have or are able to be configured to provide a fluid porous body (e.g. a porous fibrous body or porous particulate body) able to allow the passage of fluid (e.g. a gas such as for example air) there through.

The present invention in respect of another aspect relates to the preparation of active carbon materials and in particular activated carbon materials derived from cellulosic materials, whether natural or man-made. A cellulosic material may comprise a cellulosic carbohydrate material such as a polysaccharide or polysaccharide like cellulosic material; e.g. long chain structures comprising wholly or predominantly chained cyclic groups; i.e. cyclic groups having C₅₋₆, and if desired O in a cyclic group and/or O as a bridging element between chained cyclic compounds; i.e. a material containing cellobiose units.

The present invention as may be understood relates to processes for the conversion of natural or man-made cellulosic materials into activated carbon materials.

Thus, for example, a starting carbon precursor material (e.g. for a dehydration stage) may be derived from natural and/or man-made cellulosic materials comprising materials such as cellulose, modified cellulose material (e.g. rayon), cellulose like material (e.g. materials containing one or more cellobiose units), etc. The expression cellulosic material(s) include for example cellulose, rayon (i.e. viscose rayon), wood (e.g. wood chips), coconut (e.g. crushed coconut), bamboo, hemp, ramie, cotton (e.g. linen, denim), lyocell, etc. and mixtures thereof as well as mixtures with other temperature stable materials such as metal, glass and Teflon, and the like; it being understood that temperature stable is a reference to temperature stability at the temperature of the herein described heat treatment stages.

The present invention in a further aspect relates to a method(s) which open up the possibility of the preparation of an activated carbon material in relatively high yield and in particular, for example, of flexible textile like activated carbon materials. The activated carbon material (e.g. felt, cloth, etc.) thus prepared may have a relatively high density (as compared to precursor material), an adsorptive capacity>2200 m²/gram (m²/gram=square meters per gram) and an intrinsic conductivity (i.e. conductance the inverse of resistivity) which facilitates its reuse based on electrothermal regeneration thereof. The activated carbon material in the form of a woven or non-woven material may for example be exploited where the removal of organic contaminants in air is required such as mine shafts, office buildings, private residences, aircraft cabins, respirators and the like.

The present invention in accordance with another aspect further relates to an activated carbon material wherein the greater part of the total pore volume thereof has a pore size of 4 angstroms or larger, in particular a pore size of 10 angstroms or larger; for example, an activated carbon material may have at least about 80% of the total pore volume attributable to pores having a size in the range of from 4 to 500 angstroms or greater.

The present invention in particular relates to an activated carbon material having a relatively high percentage (i.e. greater than 45-50%) of the total pore volume attributable to pores thereof having a pore size in the range of from 8 angstroms to 50 angstroms or more (e.g. at least 80% of the total pore volume being attributable to pores thereof having a pore size of 8 angstroms or larger, e.g. a relatively large pore population in the range of from 8 angstroms to 50 angstroms (e.g. in particular 8 to 30 angstroms).

An activated carbon material in accordance with the present invention may, for example have a pore size distribution such that at least 65 percent of total pore volume is constituted by pores having a pore size of from 4 to 20 angstroms, up to 30 percent of total pore volume being attributable to pores having a pore size greater than 20 angstroms.

An activated carbon material in accordance with the present invention may, by way of example only, be
an activated carbon product, which may be characterized by 45% or greater of its total pore volume being attributable to the pore population having a pore size of from about 10 angstroms or larger; e.g. at least 80% of the total pore volume being attributable to pores thereof having a pore size of 10 angstroms or larger and 30 percent of total pore-volume or more being attributable to pores having a pore size equal to or greater than 20 angstroms;
an activated carbon product, which may be characterized by 70% or less of its total pore volume being attributable to pores of less than 20 angstroms in size;
an activated carbon product, which may be characterized by 95% or greater of its total pore volume being attributable to of less than 50 angstroms in size.
In accordance with the present invention an activated carbon material may have for example a BET (surface area) of at least 1200 m²/g (e.g. a BET of at least 1300 m²/g), and/or a toluene adsorption capacity of at least 0.5 g/g (grams of toluene adsorbed per gram of activated carbon material);
   such an activated carbon material may for example have a pore size distribution as described herein (e.g. at least 80% of the pores thereof having a pore size greater than 8 to 10 angstroms and less than 50 angstroms (in particular less than 30 angstroms).
   An additional aspect of the present invention relates to an activated carbon material having particular resistivity values; resistivity has units of ohms-cm.

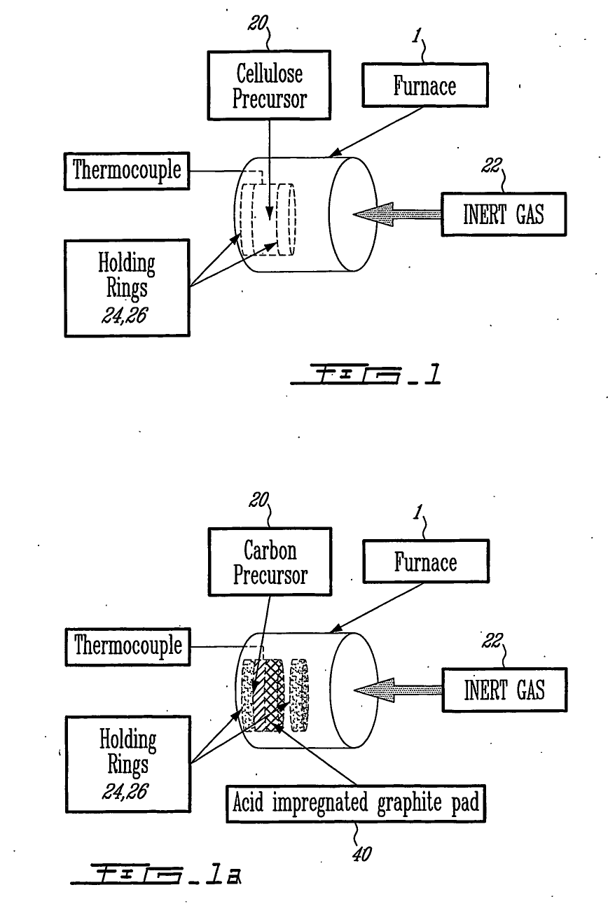

Thus the present invention in an additional aspect relates to an activated carbon material having a resistivity of up to or not more than 1000 Ohms-cm (e.g. of not more than or up to 55 ohms-cm)
Resistivity may be calculated in accordance with the following formula:

$$Resistivity ( ρ ) = \frac{Crossectional area ( {cm}^{2} ) \times Measured Resistance ( ohm )}{Distance A ( cm )}$$

Where:
   Crossectional area=(B/2)²*π
   B=Diameter in cm
   A=Length in cm
      The measured resistance may be determined using the set-up depicted in FIG. 1e; it may be measured through one centimeter of an uncompressed sample having a diameter of 0.84 cm, the measurement being made between top and bottom of sample; the readings being taken at room temperature using an ohm meter (e.g. at 22° C.).

In accordance with the present invention an activated carbon may have any combination, whatsoever, of the above characteristics, i.e. resistivity, BET, toluene adsorption etc . . .

In accordance with the present invention an activated carbon may (including an activated intermediate e.g. aromatized material as described herein) may be used for the adsorption of unwanted components or contaminants of a fluid (i.e. from a gas or liquid such as, for example, air or water).

In accordance with another aspect the present invention relates to a chemical heat treatment methodology for the manufacture or preparation of an activated carbon material from a precursor material such as for example a fibrous material. The methodology comprises one or more heat treatment stages; it may in particular comprise a carbon precursor material pretreatment stage as well as one or more carbon activation stages. The pretreatment stage is embodied in the dehydration stage mentioned above and described in more detail below. The activation stages are reflected in the carbonization, aromatization, and activation (or reformation) stages also mentioned above and described in more detail below.

It is to be understood herein that a reference to a “carbon precursor”, “carbon precursor material”, “carbonized precursor”, “activated “carbon precursor”, “carbonized precursor material”, “activated carbon precursor material” and the like is to be taken as being a reference to any carbon-containing material or substance (e.g. any dehydrated, carbonized or aromatized material) that may be chemically-thermally treated (in one or more stages as described herein) so as to be converted to be an activated carbon material or a modified activated carbon material.

The present invention as mentioned relates to and provides a (pre-treatment) process for the preparation of a dehydrated carbon precursor material which comprises subjecting a carbon precursor material to a dehydration stage,

wherein

the dehydration stage (for driving off, inter alia H₂O) comprises
   a heating step comprising heating a (predetermined) carbon precursor material, in the presence of a dehydration treatment agent, (e.g. in (the presence of) air pr if desired or necessary in the presence of an oxidation-suppressing atmosphere), at a temperature below 220° C. (e.g. at a temperature of 200° C. or less in particular for example in the range of from 160° C. to 170° C.) for a time period sufficient so as to obtain a predetermined dehydrated material (e.g. 24 hours or less).
      The obtained dehydrated carbon precursor material may be used as a starting material for another heat treatment stage.

As mentioned above dehydration treatment is to be understood herein as one wherein a reaction occurs whereby hydrogen and oxygen is (chemically) eliminated (i.e. in the form of water—H₂O) from the structure of the initial starting material. Thus dehydration stage treatment agent may be any material that is able to facilitate, enhance, promote or otherwise desirably affect a dehydration reaction whereby hydrogen and oxygen is (chemically) eliminated (i.e. in the form of water—H₂O) from the structure of the initial starting material.

In analogous fashion a carbonisation stage treatment agent, an aromatisation stage treatment agent and an activation (or reformation) stage treatment agent may respectively be; any material that is able to desirably affect the carbon removal process; any material that is able to desirably affect the hydrogen removal process; and any material that is able to desirably affect a modification of a precursor to a modified active carbon material.

In accordance with a particular aspect the present invention relates to a method or process for obtaining activated carbon which comprises an activation mechanism comprising at least one member selected from the group comprising (e.g. consisting of)
a direct activation stage, namely, an elevated heat treatment of a carbonized precursor material or as desired of a dehydrated carbon precursor material;
an aromatization stage, namely, an intermediate activated carbon activation stage for treating a carbonized precursor material to obtain an aromatized activated carbon material;
a (pyrolytic) reformation stage, namely, modification of an (e.g. intermediate) activated carbon material at an elevated temperature, (e.g. of an aromatized activated carbon material) and
sequential heat treatment stages, namely an aromatization stage followed by a (pyrolytic) reformation stage, a carbonization stage followed by an activation stage, a dehydration stage followed by an activation stage, etc.

In accordance with the present invention a starting material may be derived from an appropriate carbonization stage and if necessary or as desired from a preliminary dehydration stage. In accordance with the present invention a method or process for obtaining activated carbon may advantageously comprise a two stage activation mechanism, namely an aromatization stage followed by a (pyrolytic) reformation stage, a carbonization stage followed by an activation stage, etc.

In any event, the product of each such (heat) treatment stage may as desired or necessary be subjected to a washing/drying stage prior to subsequent use and/or be used as is for a next desired or necessary (heat) treatment stage.

In accordance with the present invention a heat treatment stage, if its temperature is high enough and depending on the nature of the treatment agent used, may advantageously be carried out in the presence of a volatilized treatment agent which is volatilized from a discrete source separate or independent from any treatment agent which may be otherwise associated with a carbonized or aromatized precursor material.

The duration of any heat treatment stage will depend on the nature and conditions of the heat treatment.

For example for dehydration the overall time will depend on the desired or necessary degree of dehydration; a long period will favour more complete conversion; so a heating period may endure for up to 48 hours or less however a shorter period may also suffice (e.g. 1 minute to 6 hours depending on the nature of the starting material e.g. thickness, fiber diameter etc.).

For the other treatment stages at higher temperature levels shorter periods of heating may be favoured in order to minimise weight loss; the durations for the other heat treatments may for example may be carried out for a period of up to 75 minutes or longer as may be desired, for example from 1 minute to 75 minutes. In any event time duration(s) may be predetermined by any suitable means; limited trial runs.

As mentioned above a (heat) treatment stage may be carried out, as desired or necessary, in the presence of at least one respective treatment agent.

In accordance with the present invention, a (heat) treatment stage for the treatment of a precursor material, depending on the nature of the material to be so treated, as well as the desired product, may be carried out, as desired or necessary, in the presence of at least one (chemical) treatment agent comprising an inorganic material.

A treatment agent, as mentioned, is intended to have, as the desired stage may require, a function of facilitating, enhancing and/or treatment or otherwise desirably affecting:
the dehydration of a carbon precursor material (i.e. a dehydration stage treatment agent);
the carbonization of a dehydrated carbonaceous material (i.e. a carbonization stage treatment agent);
the direct conversion of a carbonized material to an activated form at elevated temperature (i.e. an activation stage treatment agent);
the direct conversion of a dehydrated material to an activated form at elevated temperature (i.e. an activation stage treatment agent);
the aromatization of a carbonized material (i.e. an aromatization stage treatment agent);
the thermal rearrangement of an activated aromatized material to a modified activated form (i.e. a reformation stage treatment agent);
etc . . .
   If desired the treatment agent may be the same for two or more stages (e.g. all of the stages) as described herein; alternatively, a different treatment agent may be used for one or more or each of the stages.

A dehydration stage treatment agent, as may be surmised, is to affect dehydration in a desirable fashion; it has been found, for example, that boron based compounds may not have as desirable an effect when used alone as do phosphorous compounds. Thus, phosphorous compounds are to be preferred as discrete dehydration stage treatment agents (i.e. used alone); although mixtures of phosphorous compounds and boron based compounds may possibly be used. A dehydration stage treatment agent may in particular be selected from the group consisting of polar solvent soluble phosphorous containing inorganic lewis acid compounds.

On the other hand the carbonization stage treatment agent, the aromatization stage treatment agent and the activation/reformation stage treatment agent may each be independently selected from the group consisting of polar solvent soluble phosphorous containing acidic (i.e. inorganic) compounds, polar solvent soluble boron containing acidic (i.e. inorganic) compounds, and mixtures thereof. However, these treatment agents, in particular, may each be independently selected from the group consisting of polar solvent soluble phosphorous containing inorganic lewis acid compounds.

It is to be understood herein that for a heat treatment a reference to the presence of a treatment agent (e.g. activation inorganic material) as mentioned herein includes the presence due to prior impregnation of a precursor material with such treatment agent (e.g. inorganic material); the presence due to exposure of the precursor material to treatment agent which is a component part of a solvent/carrier mist; the presence thereof due to exposure of the precursor material to treatment agent (e.g. inorganic material) being volatilized (e.g. from a source separate or independent from any treatment agent associated with the carbon precursor material) during a suitable heat treatment stage; and the like. Thus, for example, a precursor material may be exposed to a heat treatment (of appropriate temperature) in the presence of a static or moving atmosphere comprising a volatilized treatment agent; in this case the treatment agent having a volatilization temperature below or at the treatment temperature used for treating a predetermined carbon precursor material so as to obtain a predetermined type of modified carbon material (e.g. for obtaining an activated carbon material).

In accordance with the present invention, depending on the type of heat treatment stage, a heat treatment may as desired or necessary be performed in the presence or absence of air. In accordance with the present invention, depending on the type of heat treatment stage, a heat treatment may as desired or necessary be performed in the presence of an oxidation-suppressing atmosphere (an atmosphere that is inert or at least essentially inert); such an atmosphere may, for example, be induced to pass though a carbon precursor. Also in accordance with the present invention, and again, as desired or necessary, depending on the type of heat treatment stage, a heat treatment stage may be conducted under (ambient) atmospheric pressure (or essentially atmospheric) conditions (i.e. in the presence of atmospheric oxygen); e.g. a heat treatment stage may be conducted without a preliminary purge of the atmosphere in the interior of a heat treatment device (i.e. oven). A heat treatment stage may, as desired or necessary, for example, be carried out without any gas flow there through. In any event, it is to be understood herein that any heat treatment stage is to be carried out under conditions which favor the production of the desired or necessary product of a particular heat treatment stage.

In accordance with the present invention preparation efficiency, measured as the ratio between the mass of the activated material (e.g. fabric) and the mass of the initial cellulose fiber fabric, may be greater than 30%, and typically lies in the range 36% to 38%.

In accordance with another aspect, the present invention relates to a heating system for subjecting a precursor material (for example, a non-woven precursor) for the preparation of an activated carbon comprising a porous body (e.g. porous body able to allow the passage of gas there through) to a predetermined heat treatment; i.e. a gas flow through heating system. The heating system may comprise
a gas path component having a gas intake side and a gas discharge side and defining a gas flow path;
a precursor support component for supporting said precursor material transversely across said gas flow path for the passage of gas through said precursor material (i.e. such that gas passing from said gas intake side to said gas discharge side passes through said precursor);
   and
a heating component for heating a gas to a predetermined temperature prior to gas passing through said support precursor.
   Alternatively the heating system may be of a closed system type (e.g. comprising an autoclave type heater operable for example at atmospheric pressure or greater).

As mentioned above a treatment agent may be present, during an appropriate (i.e. high temperature) heat treatment step, in a volatilized state derived from a source separate or independent from any treatment agent associated with the precursor material itself. Thus in accordance with the present invention a heating system may, if so desired or necessary, include a discrete treatment agent source element.

A treatment agent source element may, for example, in relation to gas flow through a heating system, be configured for introducing a volatilized treatment agent into a gas flow upstream of said supported precursor; e.g. the gas flow and attendant volatilized treatment agent being directed toward the face of the carbon precursor material transverse to such flow. Such a source element of volatilized treatment may take on any desired form or construction keeping in mind its purpose, namely to provide the upstream gas flow with a volatilized treatment agent content. A treatment agent source element may for example comprise a (upstream) support member for supporting a porous (fibrous) carrier body transversely across said gas flow path for the passage of gas through said carrier body, said carrier body being impregnated with treatment agent volatilizable below or at the predetermined heating temperature of the heat treatment stage. As may be appreciated the so volatilized treatment agent will be transported by the gas flow into and through the downstream carbon precursor.

A heating system as described above may be used to carry out one or more of the above activation stages for the preparation of an activated carbon material.

It is further to be understood herein that the characteristics of a desired (i.e. predetermined) product of a particular treatment stage as well as specific (i.e. predetermined) process or treatment conditions, heating equipment and starting materials necessary to obtain such product may be predetermined in any suitable fashion (e.g. by appropriate limited testing).

Thus in accordance with the present invention there is provided a method or process for the modification of a carbonaceous precursor material,
said method comprising heating said (i.e predetermined) carbonaceous precursor material, (e.g. in the presence of an oxidation-suppressing atmosphere (e.g. at least essentially inert)), in the presence of an activation stage treatment agent (e.g. including or alternatively in the presence of volatilized activation treatment agent, from a discrete source separate or independent from the carbonaceous material) at an elevated temperature higher than 650° C. (e.g. in the range of from 700° C. or higher in particular for example up to 1000° C. or more) for a time period (e.g. 5-50 minutes or longer as may be desired) sufficient so as to obtain a (i.e. predetermined, e.g. modified) activated carbon product.
   In accordance with the present invention a carbonaceous precursor material may be an activated carbon which it is desired to modify. A carbonaceous precursor material may, for example, be any suitable or desired activated carbon material which is modifiable in accordance with the present invention and may in particular be a material activated in accordance with the present invention, namely an aromatized or carbonized activated carbon precursor material. Thus a carbonaceous precursor material may for example be a carbonaceous precursor material selected from the group consisting of an (e.g. aromatized) (i.e. chemically) activated carbon precursor material (e.g. activated carbon having a graphitene like structure) and an activated (i.e. chemically) carbonized precursor material for the preparation of a (i.e. chemically) activated carbon material.

In accordance with the present invention an activation stage treatment agent may be an acidic phosphorous containing compound or any another suitable treatment agent such as described herein.

In accordance with the present invention an activation treatment agent may be a material which is polar solvent soluble (e.g. soluble in acetone, methanol, ethanol, etc.).

In accordance with the present invention an oxidation-suppressing atmosphere may comprise an oxidation-suppressing gas, said gas being statically disposed about or being induced to flow over and/or through a carbonaceous precursor material, as the case may be. In this case, if desired or necessary a (e.g. independent or separate) source of treatment agent may be disposed upstream of said carbonaceous material for the introduction of the activation treatment agent into said gas flow, said treatment agent having a volatilization temperature at or below the treatment temperature used for obtaining said of activated carbon (i.e. be at least appreciably volatalizable at such temperature).

In accordance with the present invention, any desired (i.e. predetermined) carbonized precursor material may be used for the preparation of a desired (i.e. predetermined) (e.g. chemically) activated carbon material (e.g. for a fibrous product). A starting carbonized precursor material may, for example, be an activated (i.e. chemically activated) carbon material. A starting carbonized precursor material may have a BET (surface area) of from 1200 to 1800 m²/g, an adsorption capacity of, for example, at least 0.25 g/g (based on toluene), a density of, for example, at least 0.15 g/c and a resistivity of greater than 100,000 Ohms-cm (measured in A direction—1 cm thick, 0.84 cm diameter—see FIG. 1e). A starting carbonized precursor material may, for example, be a chemically activated carbon which has been pre-impregnated with a (acidic) treatment agent The obtained activated carbon product may, for example, be an activated carbon having a BET (surface area) of from 1800 m² μg up to 2250 m²/g or more, at least 80% of the pores thereof having a pore size greater than 8 to 10 angstroms), a toluene adsorption capacity of at least 0.6 g/g, a density of at least 0.2 g/cc (depending on the starting material) and a resistivity of up to or not more than 550 Ohms-cm, e.g. up to or not more than 55 ohms-cm).

In accordance with the present invention any desired (i.e. predetermined) aromatized chemically activated carbon material (i.e. activated carbon material having a graphitene like structure) may be used for the preparation of a desired (i.e. predetermined) modified activated carbon material (e.g. for a fibrous product). A starting (i.e. aromatized) precursor material may, for example, be an activated (i.e. chemically activated) carbon material. A starting (i.e. aromatized) chemically activated carbon may for example have a BET (surface area) of up to 1800 m²/g (e.g. 1500 m²/g to 1800 m²/g), an adsorption capacity of, for example, at least 0.4 g (toluene)/g, a density of at least 0.2 g/cc, and an resistivity of greater than 550 Ohms-cm (measured in A direction—1 cm thick, diameter of 0.84 cm—see FIG. 1e). The (aromatized) chemically activated carbon precursor may for example be pre-impregnated with a (acidic) reformation treatment agent. An obtained modified activated carbon (i.e. obtained from the activated carbon precursor) may have a BET (surface area) of greater than 1800 m²/g , at least 80% of the pores thereof having a pore size greater than 10 angstroms, an toluene adsorption capacity of, for example, at least 0.6 g/g, a density of, for example, at least 0.2 g/cc (depending on the starting material) and a resistivity of not more 550 Ohms-cm, e.g. not more than 55 Ohms-cm.

In accordance with the present invention the acidic treatment agent may as mentioned herein be a polar solvent soluble acidic phosphorous containing compound.

In accordance with the present invention a method or process may if desired comprise a polar solvent (e.g. aqueous, i.e. water) washing step wherein (acidic) treatment agent (i.e. activation agent) associated with treated activated carbon is washed from said treated activated carbon.

The present invention further relates to and provides a process for the preparation of an activated carbon precursor material comprising subjecting a precursor material to a aromatization stage,

wherein

the aromatization stage (for driving off H (e.g. it is believed that the elimination of H (e.g. H₂) from the precursor structure results in the formation of a graphitene like structure)), comprises
   a heating step comprising heating a (predetermined) carbonized precursor material (e.g. in the presence of an oxidation-suppressing atmosphere), in the presence of an aromatization stage treatment agent, at a treatment temperature of up to 650° C. (e.g. in the range of from 500° C. to 650° C.) for a time period (e.g. 5-50 minutes or longer as may be desired) sufficient so as to obtain a predetermined intermediate (aromatised) (chemically) activated carbon material.

Further to the present invention there is provided a process for the preparation of (i.e. chemically) activated carbon, comprising an aromatization stage followed by a (pyrolytic) reformation stage

wherein

the aromatization stage (for driving off H (e.g. it is believed that the elimination of H (e.g. H₂) results in the formation of a graphitene like structure)) comprises
   an initial heating step comprising heating a (predetermined) carbonized precursor material (e.g. in the presence of an oxidation-suppressing atmosphere), in the presence of an aromatization stage treatment agent, (e.g. in the presence of a volatilized (acidic) treatment agent,) at a treatment temperature of up to 650° C. (e.g. in the range of from 500° C. to 650° C.) for a time period (e.g. 5-50 minutes or longer as may be desired) sufficient so as to obtain a predetermined intermediate (aromatized) (chemically) activated carbon material,
a (pyrolytic) reformation stage (it is believed that this leads to a modification of graphitene like structure, inter alia to obtain a more planar internal structure) comprising
   a subsequent heating step comprising heating an intermediate activated carbon (e.g. in the presence of an oxidation-suppressing atmosphere), in the presence of a reformation treatment stage agent (e.g. in the presence of a volatilized (acidic) reformation treatment agent), at a temperature higher than 650° C. (e.g. at a temperature higher than 700° C. in particular for example up to 1000-1200° C. and more particularly a temperature in the range of from 750° C. to 900° C.) for a time period sufficient so as to obtain a predetermined (modified) (chemically) activated carbon product.

In accordance with the present invention for the above process the aromatization stage treatment agent and reformation stage treatment agent may for example each be a polar solvent soluble acidic phosphorous containing compound.

The present invention further relates to and provides a process for the preparation of a carbonized material, comprising subjecting a carbon precursor material to a carbonization stage,

wherein

the carbonization stage (for driving off or eliminating carbon (C) from the precursor structure (e.g. eliminate carbon oxides such as CO₂ and possibly CO) comprises
   a heating step comprising heating a (predetermined) dehydrated carbon precursor material, in the presence of a carbonization stage treatment agent, (e.g. in the presence of air or in the presence of an oxidation-suppressing atmosphere), at a carbonization temperature below 450° C. (e.g. a carbonization temperature of up to 400° C. in particular for example a temperature in the range of from 250° C. to 370° C.) for a time period (e.g. 5-50 minutes or longer as may be desired) sufficient so as to obtain a (predetermined) (activated) carbonized (precursor) material.

The present invention additionally provides a process for the preparation of (e.g. fibrous) carbonised precursor material, comprising sequentially subjecting a precursor material to a dehydration stage, and a carbonization stage,

wherein

the dehydration stage (for driving off, inter alia H₂O) comprises
   a first heating step comprising heating a (predetermined) carbon precursor material, in the presence of dehydration stage treatment agent (e.g. impregnated therewith) (e.g. in (the presence of) air or if desired or necessary in the presence of an oxidation-suppressing atmosphere), at a dehydration temperature below 220° C. (e.g. at a temperature of 200° C. or less in particular for example in the range of from 160° C. to 170° C.) for a time period sufficient so as to obtain a (predetermined) dehydrated carbon precursor material (e.g. 24 hours or less)
      and
the carbonization stage (for driving off, inter alia CO₂) comprises
   a second heating step comprising heating obtained dehydrated carbon precursor material, in the presence of carbonization stage treatment agent (e.g. impregnated therewith) (e.g. in the presence of air or in the presence of an oxidation-suppressing atmosphere), at a carbonization temperature below 450° C. (e.g. a carbonization temperature of up to 400° C. in particular for example in the range of from 250° C. to 370° C.) for a time period sufficient (e.g. 5-50 minutes or longer as may be desired) so as to obtain a (predetermined) (activated) carbonized material.

The present invention also provides a process for the preparation of activated carbon material from a carbon precursor material comprising sequentially subjecting a precursor material to a carbonization stage, and an aromatization stage

wherein

the carbonization stage (for driving off for example CO₂) comprises
   a first heating step comprising heating a (predetermined) dehydrated carbon precursor material, in the presence of carbonization stage treatment agent (e.g. impregnated therewith) (e.g. in the presence of air or in the presence of an oxidation-suppressing atmosphere), at a carbonization below 450° C. (e.g. a carbonization temperature of up to 400° C. in particular for example in the range of from” 250° C. to 370° C.) for a time period (e.g. 5-50 minutes or longer as may be desired) sufficient so as to obtain a (predetermined) (activated) carbonized material
      and
the aromatization stage (for driving off, for example H₂ to form a graphitene like structure) comprises
   a second heating step comprising heating obtained carbonized material (e.g. in the presence of an oxidation-suppressing atmosphere), in the presence of an aromatization stage treatment agent, at a treatment temperature of up to 650° C. (e.g. in the range of from 500° C. to 650° C.) for a time period (e.g. 5-50 minutes or longer as may be desired) sufficient so as to obtain a predetermined (aromatized) (chemically) activated carbon material.

The present invention also provides a process for the preparation of activated carbon material from a carbon precursor material, comprising sequentially subjecting a precursor material to a dehydration stage, a carbonization stage, and a aromatization stage

wherein

the dehydration stage (for driving off, inter alia H₂O) comprises
   a first heating step comprising heating a (predetermined) carbon precursor material, in the presence of a dehydration stage treatment agent (e.g. impregnated therewith) (e.g. in (the presence of) air or if desired or necessary in the presence of an oxidation-suppressing atmosphere), at a temperature below 220° C. (e.g. a dehydration temperature of 200° C. or less in particular for example in the range of from 160° C. to 170° C.) for a time period sufficient so as to obtain a (predetermined) dehydrated material (e.g. 24 hours or less)
the carbonization stage (for driving off CO₂) comprises
   a second heating step comprising heating obtained dehydrated carbon material, in the presence of carbonization stage treatment agent (e.g. impregnated therewith) (e.g. in the presence of air or in the presence of an oxidation-suppressing atmosphere), at a carbonization temperature below 450 C (e.g. a carbonization temperature of up to 400° C. in particular for example in the range of from 250° C. to 370° C.) for a time period (e.g. 5-50 minutes r or longer as may be desired) sufficient so as to obtain a (predetermined) carbonized material
      and
the aromatization stage (for driving off, H₂ to form a graphitene like structure) comprises
   a third heating step comprising heating an obtained carbonized material (e.g. in the presence of an oxidation-suppressing atmosphere), in the presence of an aromatization stage treatment agent, at a treatment temperature of up to 650° C. (e.g. in the range of from 500° C. to 650° C.) for a time period (e.g. 5-50 minutes or longer as may be desired) sufficient so as to obtain a predetermined (aromatized) (chemically) activated carbon material.

The present invention also provides a process for the preparation of activated carbon from a carbon precursor, comprising sequentially subjecting a precursor material to a dehydration stage, a carbonization stage, an aromatization stage and a (pyrolytic) reformation stage

wherein

the dehydration stage (for driving off H₂O) comprises
   a first heating step comprising heating a (predetermined) carbon precursor material, in the presence of dehydration stage treatment agent (e.g. impregnated therewith) (e.g. in (the presence of) air or if desired or necessary in the presence of an oxidation-suppressing atmosphere), at a dehydration temperature below 220° C. (e.g. a dehydration temperature of 200° C. or less in particular for example in the range of from 160° C. to 170° C.) for a time period sufficient so as to obtain a (predetermined) dehydrated carbon precursor material (e.g. 24 hours)
the carbonization stage (for driving off, CO₂) comprises
   a second heating step comprising heating obtained dehydrated carbon precursor material, in the presence of carbonization stage treatment agent (e.g. impregnated therewith) (e.g. in the presence of air or in the presence of an oxidation-suppressing atmosphere), at a carbonization temperature below 450° C. (e.g. a carbonization temperature of up to 400° C. in particular for example in the range of from 250° C. to 370° C.) for a time period (e.g. 5-50 minutes or longer as may be desired) sufficient so as to obtain a (predetermined) (activated) carbonized material
the aromatization stage (for driving off, H₂ to form a graphitene like structure) comprises
   a third heating step comprising heating obtained carbonized material (i.e. in the presence of an oxidation-suppressing atmosphere), in the presence of an aromatization stage treatment agent, at a treatment temperature of up to 650° C. (e.g. in the range of from 500° C. to 650° C.) for a time period (e.g. 5-50 minutes or longer as may be desired) sufficient so as to obtain a (predetermined) intermediate (aromatized) (chemically) activated carbon,
the (pyrolytic) reformation stage (for modifying graphitene like structure, inter alia to render more planar internal structure) comprises
   a fourth heating step comprising heating an obtained intermediate activated carbon (e.g. in the presence of an oxidation-suppressing atmosphere), in the presence of a reformation stage treatment agent, at a temperature higher than 650° C. (e.g. a temperature higher than 700° C. in particular for example up to 1000° C.) for a time period sufficient so as to obtain a (predetermined) (modified) (chemically) activated carbon product.

In accordance with the present invention for the above process said dehydration treatment agent, said carbonization treatment agent and said reformation treatment agent may each for example be a polar solvent (e.g. water) soluble acidic phosphorous containing compound.

The present invention further provides a process for the preparation of activated carbon material, comprising a carbonization stage followed by an activation (i.e. elevated temperature) stage

wherein

the carbonization stage (for driving off, inter alia CO₂) comprises
   an initial heating step comprising heating a (predetermined) dehydrated carbon precursor material, in the presence of carbonisation stage treatment agent (e.g. impregnated therewith) (e.g. in the presence of air or in the presence of an oxidation-suppressing atmosphere), at a carbonisation temperature below 450° C. (e.g. a carbonization temperature of up to 400° C. in particular for example in the range of from 250° C. to 370° C.) for a time period (e.g. 5-50 minutes or longer as may be desired) sufficient so as to obtain a (predetermined) carbonized material
the activation stage (for obtaining a (chemically) activated carbon material) comprises
   a subsequent heating step comprising heating an obtained carbonised material (e.g. in the presence of an oxidation-suppressing atmosphere), in the presence of a activation stage treatment agent (e.g. in the presence of a volatilized activation (acidic) treatment agent,) at a temperature higher than 650° C. (e.g. a temperature higher than 700° C. in particular for example up to 1000°) for a time period sufficient so as to obtain a predetermined (chemically) activated carbon product.
      In accordance with the present invention for the above process said carbonization treatment agent and said activation treatment agent may for example each be a polar solvent soluble acidic phosphorous containing compound.

The present invention additionally provides a process for the preparation of activated carbon material from a carbon precursor comprising sequentially subjecting a carbon precursor material to a dehydration stage, a carbonization stage, and an activation (i.e. elevated temperature) stage

wherein

the dehydration stage (for driving off, H₂O) comprises
   a first heating step comprising heating a (predetermined) carbon precursor material, in the presence of dehydration stage treatment agent (e.g. impregnated therewith) (e.g. in the presence of air or if desired or necessary in the presence of an oxidation-suppressing atmosphere), at a dehydration temperature below 220° C. (e.g. a dehydration temperature of 200° C. or less in particular for example in the range of from 160° C. to 170° C.) for a time period (e.g. up to 24 hours or more) sufficient so as to obtain a (predetermined) dehydrated carbon precursor material
the carbonization stage (for driving off, CO₂) comprises
   a second heating step comprising heating an obtained dehydrated carbon precursor material, in the presence of carbonization stage treatment agent (e.g. impregnated therewith) (e.g. in the presence of air or in the presence of an oxidation-suppressing atmosphere), at a carbonization temperature below 450° C. (e.g. a carbonization temperature of up to 400° C. in particular for example in the range of from 250° C. to 370° C.) for a time period (e.g. 5-50 minutes or longer as may be desired) sufficient so as to obtain a (predetermined) (activated) carbonized material
a activation stage (for obtaining a chemically activated carbon) comprising
   a third heating step comprising heating a (predetermined) obtained (activated) carbonized material (e.g. in the presence of an oxidation-suppressing atmosphere), in the presence of a activation stage treatment agent (e.g. in the presence of a volatilized activation (acidic treatment agent,) at a temperature higher than 650° C. (e.g. a temperature higher than 700° C. in particular for example up to 1000° C.) for a time period sufficient so as to obtain a predetermined (chemically) activated carbon product.

In accordance with the present invention for the above process said dehydration treatment agent, said carbonization treatment agent, and said activation treatment agent may for example each be a polar solvent soluble acidic phosphorous containing compound.

The present invention additionally provides a process for the preparation of activated carbon material from a carbon precursor material comprising sequentially subjecting a carbon precursor material to a dehydration stage, a carbonization stage, and a aromatization stage

wherein

the dehydration stage (for driving off, H₂O) comprises
   a first heating step comprising heating a (predetermined) carbon precursor material, in the presence of dehydration stage treatment agent (e.g. impregnated therewith) (e.g. in (the presence of) air or if desired or necessary in the presence of an oxidation-suppressing atmosphere), at a dehydration temperature below 220° C. (e.g. a dehydration temperature of 200° C. or less in particular for example in the range of from 160° C. to 170° C.) for a time period (e.g. 24 hours or less) sufficient so as to obtain a (predetermined) dehydrated carbon precursor material
the carbonization stage (for driving off, CO₂) comprises
   a second heating step comprising heating an obtained dehydrated carbon precursor material, in the presence of carbonization stage treatment agent (e.g. impregnated therewith) (e.g. in the presence of air or in the presence of an oxidation-suppressing atmosphere), at a carbonization temperature below 45° C. (e.g. a carbonization temperature of up to 400° C. in particular for example in the range of from 250° C. to 370° C.) for a time period (e.g. 5-50 minutes or longer as may be desired) sufficient so as to obtain a (predetermined) (activated) carbonized material
the aromatization stage (for driving off, H₂ to from a graphitene like structure) comprises
   a third heating step comprising heating an obtained (activated) carbonized material (e.g. in the presence of an oxidation-suppressing atmosphere), in the presence of an aromatization stage treatment agent, at a treatment temperature of up to 650° C. (e.g. in the range of from 500° C. to 650° C.) for a time period (e.g. 5-50 minutes or longer as may be desired) sufficient so as to obtain a predetermined intermediate (aromatized) (chemically) activated carbon.

The present invention further relates to or provides a process for treatment of an activated carbon material associated with a polar solvent soluble activation treatment agent (i.e. as well as any polar solvent soluble activation by-product materials) comprising subjecting said activated carbon material to a (e.g. polar solvent) washing step wherein activation treatment agent (i.e. as well as by-product materials associated with said carbonized material) is(/are) washed from said carbonized material. The treatment agents may each be a polar solvent soluble acidic phosphorous containing compound.

In accordance with the present invention a (intermediate) aromatized activated carbon material may be used as an adsorbent material and/or starting material for the preparation of a reformed activated carbon material.

An activated carbon material as described herein (including an active intermediate (carbonized/aromatized) carbon material) loaded with an adsorbed organic material may be regenerated by being subjected to a suitable (predetermined) heat treatment. A carbonized material as described herein may have some useful adsorption capacity but is advantageously used as a starting material to prepare activated carbon material.

The various (chemical) treatment agents may be acidic in nature; they may for example be selected from among known types of treatment agents. A treatment agent may, for example, be an acid compound including a Lewis acid which desirably affects predetermined treatment stage. Advantageously, the acidic compound may be an acidic inorganic phosphorous containing compound. Thus for example such acid compounds include but are not limited to aluminium chloride or bromide, phosphoric acid, polyphosphoric acid, pyrophosphoric acid, metaphosphoric acid, boric acid. U.S. Pat. No. 5,202,302 describes the use of boron compounds in addition to phosphorous compounds. Subject to the comments herein a treatment agent may be selected from the group consisting of polar solvent soluble phosphorous containing acidic (inorganic) compounds, polar solvent soluble boron containing acidic (inorganic) compounds, and mixtures thereof. A treatment agent may in particular be a polar solvent soluble phosphorous containing acidic (inorganic) compound, such as for example a polar solvent phosphorous containing lewis acid inorganic compound. More particularly, a treatment agent may be selected from the group consisting of phosphoric acid, polyphosphoric acid, pyrophosphoric acid, metaphosphoric acid; the group contemplating mixtures thereof.

It is to be understood herein, that if a “class”, “range”, “group of substances”, etc. is mentioned with respect to a particular characteristic (e.g., temperature, concentration, time and the like) of the present invention, the present invention relates to and explicitly incorporates herein each and every specific member and combination of sub-classes, sub-ranges or sub-groups therein whatsoever. Thus, any specified class, range or group is to be understood as a shorthand way of referring to each and every member of a class, range or group individually as well as each and every possible sub-class, sub-range or sub-group encompassed therein; and similarly with respect to any sub-class, sub-ranges or sub-groups therein. Thus, for example,
with respect to the number of carbon atoms, the mention of the range of 1 to 6 carbon atoms is to be understood herein as incorporating each and every individual number of carbon atoms as well as sub-ranges such as, for example, 1 carbon atoms, 3 carbon atoms, 4 to 6 carbon atoms, etc.;
with respect to temperature, a temperature of above 650° C. is to be understood as specifically incorporating herein each and every individual temperature and temperature range as well as sub-range, such as for example 700° C., 750° C. to 900° C., 850° C. to 900° C., 850° C., 950° C., 800° C. to 1100° C., etc;
a temperature of up to 650° C. is to be understood as specifically incorporating herein each and every individual temperature and temperature range as well as sub-range, such as for example 500° C., 450° C. to 600° C., 550° C. to 650° C., 460° C., 560° C., 480° C. to 600° C., etc;
a temperature below 450° C. is to be understood as specifically incorporating herein each and every individual temperature and temperature range as well as sub-range, such as for example 300° C., 250° C. to 400° C., 350° C. to 400° C., 220° C., 250° C., 255° C., 280° C. to 400° C., etc;
a temperature of below 220° C. is to be understood as specifically incorporating herein each and every individual temperature and temperature range as well as sub-range, such as for example 200° C., 150° C. to 200° C., 175° C. to 200° C., 180° C., 195° C., 180° C. to 200° C., etc;
with respect to reaction or heating time, a time of 1 minute or more is to be understood as specifically incorporating herein each and every individual time, as well as sub-range, above 1 minute, such as for example 1 minute, 3 to 15 minutes, 1 minute to 20 hours, 1 to 3 hours, 16 hours, 3 hours to 20 hours etc.;
with respect to resistivity, a resistivity of not more than 550 Ohms-cm is to be understood as specifically incorporating herein each and every individual resistivity embraced therein as well as each sub-range, such as for example (per cm) 0.5 Ohm-cm to 10 Ohm-cm, 1 ohm-cm, 70 Ohms-cm, 3 to 15 Ohms-cm, 20 to 60 Ohms-cm, less than 60 Ohms-cm, up to 500 Ohms-cm, etc.;
and similarly with respect to any other parameters whatsoever, such as pore volume, pore size, % pore volume represented by or attributable to pore size (e.g. minimum or maximum size) value or size range, pressure, concentrations, elements, (carbon) atoms, etc . . .

It is in particular to be understood herein that for any group or range, no matter how defined, a reference thereto is a shorthand way of mentioning and including herein each and every individual member described thereby as well as each and every possible class or sub-group or sub-class of members whether such class or sub-class is defined as positively including particular members, as excluding particular members or a combination thereof; for example an exclusionary definition for a formula may read as follows: “provided that when one of A and B is —X and the other is Y, —X may not be Z”.

It is also to be understood herein that “g” or “gm” is a reference to the gram weight unit and in relation to temperature “C”, or “° C.” is a reference to the Celsius temperature unit.

An activated carbon material (e.g. activated carbon material derived from a cellulose-based material) whose preparation is describe herein may be used as a regenerable adsorptive filter for the effective removal of gaseous organic contaminants and odours from air streams. Such a filtration system can be used to advantage in industrial ventilation system where solvent recovery is desired; in office building HVAC systems to remedy indoor air quality problems; in chemical laboratories to prevent the release of toxic organic chemicals in the environment; in aircraft cabins, passenger compartments in trains and vehicles to control odours; in private residences to control exposure to noxious chemicals; in respirators to protect worker or soldier's health when exposed to deadly toxicants. In fact, it is one of the advantages of this invention that it can be integrated in virtually all types of systems where the removal of gaseous contaminants from an air stream is desired.

As discussed herein the present invention may, for example, exploit up to four distinct phases or stages, namely: dehydration, carbonization, direct activation, aromatization, and pyrolytic reformation (thermal rearrangement) of a cellulosic precursor—i.e. so as to provide respectively, a low temperature char (LTC), a medium temperature char (MTC), a high temperature char (HTC) as well as an elevated temperature char (ETC); a char as described herein, may be used as a starting material for the preparation of a higher temperature char or for other purposes.

One of the advantageous features of this invention described herein is the elevated temperature char. It may for example have a surface area in excess of 2300 m²/gram, a porosity tailor made for the efficient removal of a range of gaseous organic contaminants (adsorptive capacity in excess of 50% of its weight in organics), a total pore volume in excess of 1.0 cc/g (>80% of pores>10 Å), a bulk density equal to or greater than 75% of the initial precursor's bulk density; an elevated temperature char may also be relatively tear resistant and have a resistivity of less than 550 Ohms-cm (in particular for example not more than 55 ohm-cm which corresponds to 100 ohms for a 0.84 cm diameter sample, 1 cm long, uncompressed, measured top to bottom at room temperature. (e.g. at 22 C)) for facilitating electrothermal regeneration. Thus elevated temperature char (ETC) may for example be used as an “electrothermally regenerable air filter element” in a structure such as is described in U.S. Pat. No. 5,827,355, or as an “electrical heater element” as described in U.S. Pat. No. 6,107,612. An activated material in accordance with the present invention may for example have a particular or characteristic pore distribution profile.

The elevated temperature char may also be prepared economically from readily available recycled and inexpensive cellulose-based textile precursors such as denim making the final product very competitive with the more widely used granular activated carbon.

The medium (MTC) and high (HTC) temperature chars may be considered as final products in their own right. Although they may have different adsorptive capacity than the final product and are more microporous in nature and do not lend themselves easily to be electrothermally regenerated, they may be produced in relatively high yields with the use of less energy and reagents and their properties may be relatively superior to similar single use commercially available activated carbons. Moreover, the (spent) medium and high temperature char may be advantageously submitted to a pyrolytic reformation type step with no other pre-treatment than that contained in the method for this step to produce an elevated temperature char.

In the following the present invention will be described by way of example only, in more detail, in relation to the preparation of a (fibrous) activated carbon material from carbon precursor materials based on cellulose, cellulose like materials including man made modified cellulose materials

Advantageously, in accordance with the present invention one may (predetermine in any suitable manner such as by appropriate limited testing) tailor the amount of reagent and heating conditions to the particular cellulose-based precursor used in order to obtain a desired or necessary yield as well as properties of the so predetermined final as well as intermediate product(s). This usually requires a limited number of pre-trial runs to determine the optimal conditions. However, once determined these conditions will yield a desired product in a desired yield (e.g. a yield which may be a substantially theoretical yield). It should also be noted that the conditions detailed herein for the viscose rayon precursor are not that far removed from those for any other cellulose-based precursor and the amount of experimentation required is not extensive. The reaction vessels and accessories required for the preparation of the products listed herein must of necessity be corrosion resistant and most advantageously be constructed of a superior grade stainless steel.

As described above the present invention in one aspect exploits—a dehydration stage (i.e. for driving off H₂O).

In accordance with the present invention the initial dehydration stage is of course to be carried out under conditions that favor dehydration, namely removal of water from the structure of the precursor material. Conditions are to be avoided which favor hydrolysis type reactions, i.e. conditions are to be avoided which promote reaction(s) favoring the breakage of ether linkages.

Thus the dehydration stage may comprise
an impregnation step comprising incorporating a polar solvent soluble acidic dehydration stage treatment agent via a low boiling point (e.g. anhydrous) fluid (solvent) carrier vehicle (e.g. a boiling point of 100° C. or less) into a carbon precursor material so as to obtain a dehydration stage treatment agent impregnated carbon precursor material (e.g. containing 20 to 35% by weight (i.e. on a weight/weight (w/w) basis), preferably 25-30% by weight) the impregnation step including
   a drying step comprising driving off the low boiling point (anhydrous) fluid carrier so as to obtain a (i.e. anhydrous) dehydration agent impregnated carbon precursor material at least essentially free of said fluid carrier (especially free of water);
a first heating step comprising heating (e.g. in a heating system as shown in FIGS. 1 and 1c) the dehydration agent impregnated carbon precursor material, (e.g. in the presence of air or if desired or necessary in the presence of an oxidation-suppressing environment (e.g. atmosphere), at a dehydration temperature below 220° C. (e.g. a dehydration temperature 200° C. or less in particular for example in the range of from 160° C. to 170° C.) for a time period sufficient so as to obtain a dehydrated material (which may for example, have a BET (surface area) of up to 50 m²/g, a negligible if not non-existent adsorption capacity, a density which may for example be of at least 90% of the density of the initial starting precursor material and a relatively high resistivity in the megaOhms-cm).
and if desired or necessary a polar solvent washing step wherein dehydration agent as well as by-product materials associated with said dehydrated material is/are washed from said dehydrated material. Advantageously the dehydration may be carried out in the presence of air—lower costs will be involved than if an inert atmosphere is to be used.

In accordance with the present invention the initial raw precursor (i.e. starting) carbon containing material may be formed of naturally derived cellulosic fibers, such as those derived from cotton, linen, ramie, hemp, wood, etc. or man-made cellulosic fibres, such as those derived from regenerated cellulose fibres rayon (e.g. viscose rayon), lyocell. The initial raw precursor material may take the form of a textile or textile like material, whether woven or non-woven including a felt like material.

A carbon precursor used in the process(es) described herein for the preparation of an activated carbon may be a natural or man-made cellulose-based material. Examples of natural cellulose-based material, as mentioned above, include but are not limited to: cotton, linen, ramie, hemp, and combinations of these in any conceivable proportions. This also includes natural cellulose-based materials that have been subjected to processes to enhance their (textile) properties such as, denim, mercerized cotton and others. The precursors may be a textile or textile like material that is woven, knitted or felted. Man-made cellulose-based textile include but are not limited to viscose rayon and lyocell and may include the latter in combination with natural cellulose based materials e.g. viscose rayon-cotton or heat resistant synthetic fibres such as Teflon e.g. viscose rayon-teflon in any conceivable combinations. Advantageously, the viscose rayon or lyocell precursor may be a non woven felt of high density. The precursors may in any event be in any suitable or desired fibrous format such as for example in woven, knitted of felted format. A precursor material may be used as received’; it may for example be recycled textile or fabric material that has been dyed provided that the dye or other additive associated with the fibre material does not interfere in the dehydration process which may be predetermined in any suitable manner as by limited preliminary testing. Combinations of man-made and natural cellulose-base material may also be used. Examples include: ramie-viscose rayon, cotton-lyocell. Advantageously, the viscose rayon or lyocell precursor may be a non woven felt of highest possible density.

The dehydration stage treatment agent may, for example, be an acid compound including a Lewis acid which desirably affects a dehydration reaction i.e. elimination of water. Advantageously, the acidic compound may be a phosphorous containing compound; in particular inorganic acid phosphorous compounds. Thus for example such acid compounds include but are not limited to: aluminium chloride or bromide, phosphoric acid, polyphosphoric acid pyrophosphoric acid, and metaphosphoric acid. Any other type of (known) acid reagents (i.e. weak nucleophilic) can be used to dehydrate the precursor provided that they desirably affect the dehydration reaction. Advantageously, phosphoric acid technical reagent grade (85% w/v), density 1.685 gram/cc is used

The dehydration stage treatment agent may be incorporated into the precursor by use of a (e.g. non-aqueous) low boiling point (e.g. anhydrous) fluid (polar solvent) carrier vehicle (e.g. a boiling point of 100° C. or less) so as to obtain a dehydration agent impregnated material). If water is used as a carrier then special care is to be taken to drive all or at least substantially all of the water off during the drying stage discussed below since the presence of water during the dehydration step may result in unwanted cleavage of cellulosic ether linkages (i.e. breakdown of the cellulosic polymer chain length); organic solvents are preferred (e.g. acetone, methanol, ethanol, propanol, etc).

As discussed below phosphoric acid may also advantageously be used for activation, carbonization, aromatization, and reformation process stages, although other of the reagents previously mentioned may also be used.

The initial impregnation treatment for dehydration may in particular comprise the use of an acidic (inorganic) phosphorous compound using a polar solvent as carrier such as an organic solvent such as acetone. Thus phosphoric acid technical reagent grade, 85%, density 1.685 gram/cc may be used to impregnate a cellulose-based precursor in association with a solvent such as acetone, etc. The solvent may advantageously be an organic solvent such as acetone or methanol. Although methanol as well as acetone may advantageously be used to imbue the precursor with phosphoric acid, other volatile organic solvents capable of dissolving phosphoric acid can be used including other lower alcohols such as for example, ethanol, propanol, etc.

The impregnation step may thus include a drying sub-step comprising driving off the low boiling point (anhydrous) fluid carrier so as to obtain a (water) dry (i.e. anhydrous) dehydration agent impregnated material at least essentially free of said fluid carrier (especially of free water); i.e. to attenuate side hydrolysis reactions which may, for example, occur and tend to break down the long chain ether bonds of hydrocarbons present in a precursor material.

The (dried) dehydration treatment agent impregnated carbonaceous material is thereafter subjected to a first heating step comprising heating the impregnated material, (i.e. in the presence of air or if desired or necessary in the presence of an oxidation-suppressing environment (e.g. atmosphere such as an inert gas such as for example, nitrogen, helium or argon)), at a temperature below 220° C. (e.g. a temperature below or not more than 200° C. in particular for example in the range of from 150° C. to 170° C.) for a time period sufficient so as to obtain a dehydrated material (e.g. 24 hours or less). The heating may occur in a suitably configured gas flow through oven in an oxidation-suppressing atmosphere or even an ordinary oven (e.g. without gas flow though). Alternatively, the heating may possibly be carried out in a Parr bomb with the impregnated material being submerged in a suitable polar or non polar solvent and heated to an appropriate temperature without scorching.

If desired or necessary the obtained product may be cooled and subjected to a polar solvent washing step wherein dehydration agent as well as by-product materials associated with said dehydrated material is/are washed from said dehydrated material. The polar solvent may be water; or it may be acetone due to its lower boiling point. The so washed product may then be (air) dried at room temperature over a suitable period of time so as to obtain a (solvent) dried product.

The obtained dehydrated material may for example have a BET of 35 m²/g and a resistivity in the megaohm-cm range.

Thus more particularly, a cellulose-based carbon precursor may be pre-treated by submerging the material in a solution of phosphoric aced in methanol or acetone at a concentration of 8.0 to 20.0 grams/100 cc for 60 to 180 seconds and preferably for 90 seconds or even left to soak for example for at least one hour. The final amount of phosphoric acid incorporated into the precursor selected may advantageously range between 20 and 35% weight/weight and more advantageously 30 to 35% by weight. To facilitate drying the treated sample may be passed through a wringer and may then be air dried for several hours in a well ventilated booth. The phosphoric acid treated material may then be mounted in a high temperature oven (such as for example a gas flow through device as described herein below) and heated at a low rate, preferably 1° C./minutes, up to a temperature of 140° C. to 190° C. and advantageously to 170° C. under inert gas (nitrogen, helium or argon) flow of 50 to 250 cc/minute and, advantageously at 150 cc/minute, or in air without gas (i.e. air) flow, for 18 to 48 hours and preferably for 24 hours or less (e.g. six hours). The treated material may then be allowed to cool to room temperature over a period of one hour. The phosphoric acid can either be removed from the treated material by repeated washing with water or be left, as is, for the next step. The final yield obtainable may be from 60 to about 68% by weight (the latter limit being about the theoretical yield). The dehydration step determines the yield of all subsequent char types obtainable therefrom. Although methanol may advantageously be used to imbue the precursor with phosphoric acid, other volatile solvents capable of dissolving phosphoric acid can be used including ketones such as acetone, as well as other alcohols such as ethanol, propanol, etc.

Advantageously, a more homogeneously phosphoric acid impregnated cellulosic precursor may be obtained by placing the sample in a filtration device, allowing the phosphoric acid-methanol solution to percolate through the sample for a suitable period of time (e.g. one hour or less) and applying flash filtration to the sample for a predetermined amount of time.

The dehydration of the precursor may as mentioned alternatively, be performed in a Parr bomb using the following conditions: precursor may be submerged in a solution of concentrated phosphoric acid (85% w/v) in a polar or non-polar, 6.0 grams/100 cc in a sealed Parr bomb and heated for 5.0 to 8.0 hours or less at 140° C. to 190° C. under an inert gas atmosphere (nitrogen, helium, or argon). The final product may be removed from the device, if necessary rinsed with a solution of cyclohexane/methylene chloride or any other suitable solvent or solvent mixture, followed by a repeated wash in water to remove reagent and air dried for a desired period of time (e.g. several hours).

The final product, a low temperature char, either washed essentially free of reagent or left as is, does not require any special storage conditions until used for the next step. The product, washed or unwashed can be stored at room temperature for long periods of time without any deleterious effects. The washed low temperature char may have a low surface area (BET 0 to 40 m²/gram), a large resistance (>1.0 megaohm for a 0.84 cm diameter sample, 1 cm long, uncompressed, measured top to bottom at room temperature (e.g. at 22° C.)) and a bulk density of 90% that of the starting material (i.e. due to volumetric shrinkage of 30 to 40%) [a high bulk density (>0.15 gram/cc)]. This density depends to a large extent on the density of the precursor. The average elemental composition of the low temperature char is: carbon: 71.1%, H, 4.16%, and O: 24.8%.

The present invention in another aspect exploits—a carbonization stage (for driving off, CO₂). In accordance with the present invention the carbonization step is to be carried out under conditions that desirably affect reaction(s) favouring the elimination of carbon dioxide.

Thus the carbonization stage (for driving off, inter alia CO₂) may comprise
if necessary or desired an impregnation step (advantageously, an homogeneous impregnation achieved as described above) wherein a dehydrated carbon precursor material (used as is or cleaned of residual chemical materials or process by-products) is associated with (i.e. impregnated with) an (e.g. acid) carbonization treatment agent so as to obtain a carbonization stage treatment agent impregnated material, i.e. an impregnation step comprising incorporating a polar solvent soluble carbonization treatment agent via a low boiling point fluid (solvent) carrier vehicle (e.g. a boiling point of 100° C. or less) into the material so as to obtain a carbonization treatment agent impregnated material, the impregnation step including if desired or necessary
   a drying step comprising driving off the low boiling point (anhydrous) fluid carrier so as to obtain a dry carbonization treatment agent impregnated material at least essentially free of said fluid carrier;
a second heating step comprising heating (e.g. in a heating system as shown in FIGS. 1 and 1c) an (acid) carbonisation treatment agent impregnated material obtained from the drying step mentioned above, (e.g. in the presence of air or in the presence of an oxidation-suppressing atmosphere), in a high temperature oven (such as for example a gas flow through device as described herein below) at a temperature below 450° C. (e.g. a temperature of up to 400° C. in particular for example in the range of from 250° C. to 370° C. such as 340° C. to 360° C.) for a time period sufficient (e.g. 10 to 45 minutes) so as to obtain a carbonized material (e.g. in high yield approaching theoretical i.e. about to 36 about 40%) [e.g. a carbonized material having a BET (surface area) of from 1200 to 1800 m²/g, an adsorption capacity (for toluene) of at least 0.25 g/g, a density of greater than 80% of the density of the initial carbonaceous precursor—due to shrinkage [e.g at least 0.15 g/cc], a resistivity of for example greater than 55,000 ohm-cm or a resistance of 100,000 ohms for a 0.84 cm diameter sample, 1 cm long, uncompressed, measured top to bottom at room temperature (e.g. at 22° C.) and a Butane number of 25 to 40 g butane per 100 g of sample.
if desired or necessary a polar solvent washing step wherein (acid) carbonization treatment agent as well as by-product materials associated with said carbonized material is/are washed from said carbonized material.

The carbonization stage treatment agent may, for example, be an acid compound which desirably affects the elimination of carbon dioxide e.g. an acid compound may be an acid compound such as described above with respect to the dehydration agent as well as some other reagent such as for example, ammonium chloride, ammonium borate and boric acid, etc. Advantageously, the acidic compound may be a phosphorous containing compound such as for example those described above. Thus, the product of the dehydration step, (i.e. the low temperature char), may be further treated (i.e. impregnated) with a treatment agent (the same or different) (such as for example phosphoric acid) either directly or after the washing stage described with respect to the dehydration step.

The carbonisation treatment agent may also be incorporated into the product produced by the dehydration step by use of a low boiling point fluid (polar solvent) carrier vehicle (e.g. a boiling point of 100° C. or less) so as to obtain an (acid) carbonization treatment agent impregnated material (e.g. water, acetone, etc.). The fluid (polar solvent) carrier vehicle may thus be a fluid as described above with respect to the dehydration step or stage.

The carbonization stage treatment agent impregnation treatment may thus in particular comprise the use of an acidic (inorganic) phosphorous compound using a (low boiling point) polar solvent as carrier such as water or and organic solvent such as acetone or methanol. Thus phosphoric acid technical reagent grade, 85%, density 1.685 gram/cc may be used to impregnate a cellulose-based precursor in association with a solvent. The solvent may advantageously be another organic solvent such as ethanol.

The carbonization treatment agent impregnation step may be followed by a drying step comprising driving off the low boiling point fluid carrier so as to obtain a dry carbonization treatment agent impregnated material at least essentially free of said fluid.

The (dehydrated) carbon precursor material obtained directly from the dehydration step or a carbonization treatment agent impregnated dehydrated material obtained from the drying step mentioned above may thereafter be subjected to a second heating step comprising heating such precursor material, in a high temperature oven (such as for example a gas flow through device as described herein below), in an oxidation-suppressing environment (e.g. atmosphere such as an inert gas such as for example, nitrogen, helium or argon), at a carbonization temperature (i.e. a temperature favouring carbonization) above 220° C. (e.g. in the range of from 340° C. to 370° C.) for a time period sufficient so as to obtain a carbonized material (e.g. for 10 to 45 minutes e.g. 15 minutes). The heating may occur in a suitably configured oven in an oxidation-suppressing atmosphere (see for example FIGS. 1 and 1c) or alternatively in air. Alternatively, the heating may be carried out in a Parr bomb in the presence of a polar or non-polar solvent as well as appropriate treatment agent, heated to the appropriate temperature without scorching.

If desired or necessary the obtained carbonized product may be cooled and subjected to a polar solvent washing step wherein catalyser agent as well as by-product materials associated with said carbonized material is/are washed from said carbonized material. The polar solvent may be water or advantageously methanol or acetone due to their lower boiling point. The so washed product may then be (air) dried at room temperature over a suitable period of time so as to obtain a (solvent) dried product.

Thus more particularly, the product of the dehydration step, i.e. the low temperature char (LTC), may be used ‘as is’ that is, as produced by the dehydration step or washed with water to remove phosphoric acid. In both instance, the dehydration step product may be treated with phosphoric acid by submerging it in a solution of concentrated phosphoric acid in methanol or acetone (20 to 30 grams phosphoric acid/100 ml methanol or acetone and more advantageously 25-28 grams phosphoric acid/100 ml acetone) for three minutes to obtain an impregnated low temperature char containing 30 to 50% w/w phosphoric acid and more advantageously 35 to 45% w/w. The treated or impregnated low temperature char may then be allowed to dry overnight at room temperature in a well ventilated booth. The acid treated low temperature char may then be mounted in a high temperature oven (such as for example a device illustrated in FIGS. 1 and 1c) and heated to 250° to 400° C. and preferably at 340° C. to 370° C. for 10 to 60 minutes and more advantageously for 10 to 30 minutes (e.g. for 10 to 20 minutes); the heat treatment may be carried out under an inert gas (nitrogen, helium or argon) at a flow rate of 50 to 200 ml/minute and preferably 120 to 150 ml/minute or in air with no air flow. The yield of product may range from 36 to 40% or almost theoretical.

The carbonization step may possibly also be performed in a sealed Parr bomb in the presence of a polar or non-polar solvent as well as appropriate treatment agent, and heating under an inert atmosphere (nitrogen, helium, argon). The product, obtained may be washed essentially free of solvent using an appropriate solvent or solvent mixture and air dried in a well ventilated hood for the removal of solvent.

The product of the carbonization step, a medium temperature char, can either be used ‘as is’ or washed essentially free of acid for a further treatment step. It does not require any special storage conditions and can be stored for long periods at room temperature without any deleterious effects.

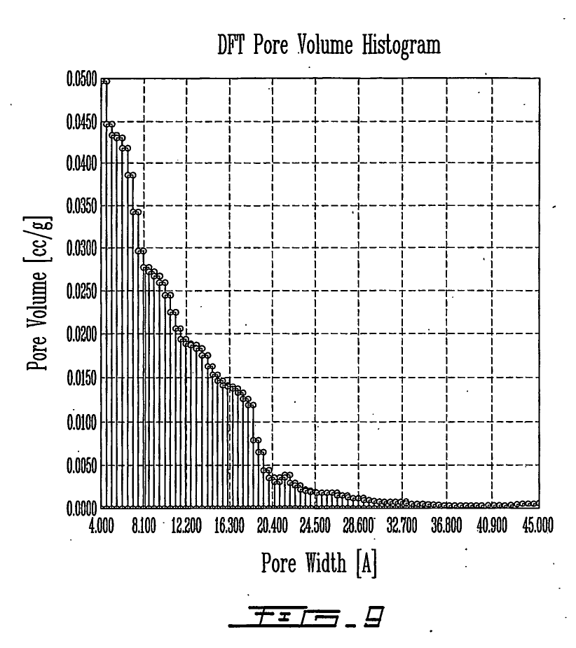

The washed medium temperature char (MTC) may have an adsorptive capacity which ranges from 1000 to 1900 m²/gram, a high bulk density—e.g. a density greater than 80% of the density of that of the starting material) (e.g. >0.13 gram/cc depending on the initial starting material) and a resistivity which may range from 50 kilo Ohms-cm to >1.0 mega Ohms-cm and, as such, cannot be readily electrothermally regenerated. Its porosity may range from 5 to 30 Å pore diameter with less than 45% of its pore volume having pores greater than 10 angstroms. Most of the surface area for this intermediate may reside in the 5.0 to 10.0 Å pore width range its total pore volume may generally be less than 0.8 cc/g and its micropore volume may be less than 0.6 cc/g. The carbonization step affects the porosity of the obtained product and also thus affects the porosity of the subsequent chars. The pore volume distribution profile for this type of char is physically different in relation to that of other types of chars (see FIG. 9). Its measured adsorptive capacity for toluene may be 250 to 350 mg/gram at 40 to 70% relative humidity; the contact time with the sorbent was 0.8 seconds. The average elemental composition of the medium temperature char is carbon: 89.6%, H, 2.63%, and O: 7.77%.

The present invention in another aspect exploits—a aromatization stage (for driving off, inter alia H₂ to form a graphitene like structure).

Thus a aromatization stage (for driving off, H₂ to form a graphitene like structure) may comprise
if desired or necessary an impregnation step wherein a carbonized precursor material is associated with (i.e. impregnated with) a aromatisation stage treatment (chemical) agent (i.e. an agent for favouring (the conversion of or) the formation of aromatic like structures) i.e. an impregnation step comprising incorporating a polar solvent soluble aromatisation stage treatment agent via a low boiling point fluid (solvent) carrier vehicle (e.g. a boiling point of 100 C or less) into a carbonized material so as to obtain a aromatisation treatment agent impregnated material, the impregnation step including if desired or necessary
   a drying step comprising driving off the low boiling point) fluid carrier so as to obtain a dry aromatisation treatment agent impregnated material at least essentially free of said fluid carrier;
a heating step comprising heating carbonized precursor material (e.g. in an oven system as shown in FIGS. 1b and 1c) obtained directly from the carbonization step or said aromatization stage treatment agent impregnated material obtained from said drying step, (e.g. in the presence of an oxidation-suppressing atmosphere, (e.g. in the presence of a volatilized (acidic) aromatization treatment agent derived from an independent aromatization treatment agent source,) at a treatment temperature in the range of up to 650° C. (e.g. in the range of from 500° C. to 650° C.) for a time period sufficient so as to obtain an (intermediate) (aromatized) activated carbon (e.g. in a 32 to 38% yield (theoretical 38%)); the product may have a BET (surface area) of from 1500 to equal to or greater then 2000 m²/g, an adsorption capacity for toluene of at least 0.4 g/g, a density of at least 80% of that of the starting material [e.g. of at least 0.2 g/cc] and a resistivity greater than 550 Ohms-cm, (said (e.g. acidic) aromatization treatment agent being polar solvent (e.g. water, acetone, etc.) soluble)
[if desired or necessary] a polar solvent washing step wherein aromatization treatment agent as well as by-product materials associated with said activated carbon material is/are washed from said (intermediate) activated carbon material.

The aromatization stage treatment agent (i.e. chemical gent) may, for example, be an acid compound which desirably affects driving off, inter alia H₂ to form (what is believed to be) an aromatic graphitene like structure, e.g. an acid treatment compound may be an acid compound such as described above with respect to the dehydration or carbonization stage treatment agents. Advantageously, the aromatization treatment agent may be a phosphorous containing compound such as for example those described above. Thus, the product of the carbonization step, (i.e. the medium temperature char), may be further treated (i.e. impregnated) with aromatization stage treatment agent (e.g. again phosphoric acid) either directly or after the washing stage described with respect to the carbonization step.

The aromatization treatment agent may also be incorporated into the product produced by the carbonization step by use of a low boiling point fluid (polar solvent) carrier vehicle (e.g. a boiling point of 100° C. or less) so as to obtain a reforming agent impregnated material (e.g. methanol, acetone, etc.). The fluid (polar solvent) carrier vehicle may thus be a fluid as described above with respect to the dehydration step or stage.

The aromatisation stage treatment agent impregnation treatment may thus in particular also comprise the use of an acidic (inorganic) phosphorous compound using a polar solvent as carrier such as an organic solvent such as methanol or acetone. Thus phosphoric acid technical reagent grade, 85%, density 1.685 gram/cc may be used to impregnate a cellulose-based precursor in association with a solvent such as a ketone, or alcohol such as for example methanol, acetone, etc. The solvent may advantageously be an organic solvent such as methanol.

The treatment agent impregnation step is followed by a drying step comprising driving off the low boiling point (anhydrous) fluid carrier so as to obtain a dehydration agent impregnated material at least essentially free of said fluid carrier.

The carbonized precursor material obtained directly from the carbonization step (i.e. an aromatization treatment agent impregnated material) or an aromatisation treatment agent impregnated carbonized material obtained from the drying step mentioned above may thereafter be subjected to a third heating step comprising heating such material, in an oxidation-suppressing environment (e.g. atmosphere such as an inert gas such as for example, nitrogen, helium or argon), if desired or necessary in the presence of a volatilizable aromatisation treatment agent, at a temperature above 500° C. (e.g. in the range of from 500° C. to 650° C.) for a time period sufficient so as to obtain an aromatized material. The heating may occur in a suitably configured oven (FIGS. 1 and 1c) in an oxidation-suppressing atmosphere.

The obtained aromatized product may be cooled (to room temperature) and subjected to a polar solvent washing step wherein acidic activation agent as well as by-product materials associated with said aromatized material is/are washed from said aromatized material. The polar solvent may be water or advantageously methanol or acetone due to their lower boiling point. The so washed product may then be (air) dried at room temperature over a suitable period of time so as to obtain a (solvent) dried product.

Thus more particularly, the medium temperature (i.e. carbonized) char may be used ‘as is’ or water washed (prior to further agent impregnation) for the aromatization step. In both instances, the medium temperature char may be submerged in a solution of concentrated phosphoric acid in methanol (10 to 35 grams/100 ml methanol, and preferably 35 gram/100 cc methanol) for three minutes and may be air dried at room temperature in a well ventilated booth overnight. Advantageously, a more homogeneous impregnation of the sample may be obtained using the procedure described earlier. The aromatization treatment agent impregnated intermediate (activated) material may then be mounted in a high temperature, gas flow through, oven as described herein but modified to mount a further upstream graphite felt member holder (FIGS. 1b and 1c) and heated at 500° C. to 650° C. and more advantageously at 600° C. for 10 to 45 minutes and preferably 20 minutes under an inert gas (nitrogen, helium, argon, carbon dioxide) at 50 to 150 ml/minute and advantageously at 70 to 80 ml/minute. It should be noted that for this example embodiment of the present invention the aromatization impregnated carbonized material may be preceded by a similarly (phophorous) impregnated (porous) graphite felt upstream (see FIG. 1b) of the inert gas flow to effectively serve as a source of treatment agent so as to replenish the agent lost from the carbonized material due to loss during the heat treatment process. If such replenishment is not provided for in the gas flow through reactor or oven configuration, the product may have an undesirably relatively low BET e.g. less than 600 m²/g. The final product is washed essentially free of acid with water and dried in an oven at 100° C. for one or more hours. The yield of High Temperature Char may range from 32.0 to 36.0% by weight or almost theoretical (38%).

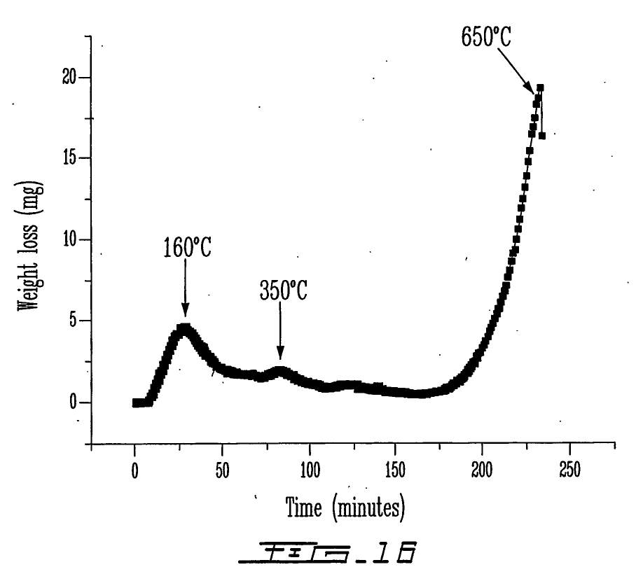

The washed high temperature char may have an adsorptive capacity of 1500 to >2000 m²/gram, a high bulk density greater than 80% of that of the precursor density (e.g. >0.12 gram/cc) and a resistivity of greater than 550 Ohms-cm. As such, the product cannot be easily electrothermally regenerated. Its, porosity may range from 5.0 to 50.0 angstroms pore size or width with 50 to 60% of the pore volume found for pores greater than 10 angstroms. Total pore volume is usually less than 0.9 cc/g and its micropore volume is less than 0.7 cc/g. The pore volume distribution is physically different from known activated carbon (see FIG. 15). Its measured adsorptive capacity for toluene may be 400 to 500 mg/gram and it may be 300 to 400 mg/gram for carbon tetrachloride determined at 45 to 65% relative humidity. Contact time with the sorbent was 0.8 seconds. The average elemental composition for this product is carbon: 94.7%, H, 2.39%, and O: 2.92%. The product is resilient and tear resistant.

The present invention in another aspect exploits—a (pyrolytic) reformation stage (for modifying graphitene like structure, inter alia to render more planar internal structure).

Thus a (pyrolytic) reformation stage (for modifying graphitene like structure, inter alia to render more planar internal structure) may comprise
an impregnation step wherein an (aromatized) intermediate activated carbon precursor material is associated with (i.e. impregnated with) a reformation stage treatment agent (in a manner analogous to that described above with respect to the other stages), the impregnation step including if desired or necessary a drying step also as described above;
a reformation heating step comprising heating said (impregnated) aromatized activated carbon (e.g. in an oven system as shown in FIGS. 1b and 1c) in an oxidation-suppressing atmosphere, (e.g. in the presence of a volatilized (acidic) reformation treatment agent derived from an independent reformation treatment agent source,), at a temperature higher 650° C. (e.g. at a temperature than 700° C. in particular for example up to 1000° C. or more particularly for example in the range of from 750° C. to 950° C.) for a time period sufficient so as to obtain a (modified) activated carbon product; the (modified) activated product may have a BET (surface area) of greater than 1900 m²/g (e.g. greater than 2300 m² μg), an adsorption capacity of at least 0.6 g/g, a density of at least 80% that of the precursor material [e.g. at least 0.2 g/cc] and a resistivity of less than 55 Ohms-cm (said (acidic) stabilization agent being polar solvent (e.g. water, acetone, etc.) soluble).

The reformation treatment (chemical) agent may, for example, be an acid compound desirably affects changes to a more ordered structure, inter alia to render more planar internal structure. It is believed that the reformation stage treatment agent; at the restructuring temperature is in a volatilized form and as in the case of the volatilized aromatization agent for the aromatization stage, is able to lodge in the pores of the treated material and may be removed by washing after the material is cooled. Such a reformation stage treatment agent may be an acid compound such as described above with respect to the dehydration agent as well as with respect to the carbonization and aromatization stage treatment agents. Advantageously, the reformation agent may be a phosphorous containing compound such as for example those described herein. Thus, the product of the aromatization stage, (i.e. the high temperature char), may be used ‘as is’ directly for the reformation heating step i.e. after being treated (i.e. impregnated) with reforming agent (e.g. phosphoric acid) either directly or after the washing stage described with respect to the aromatization stage.

The reformation stage treatment agent may also be incorporated into the product produced by the aromatization step by use of a low boiling point) fluid (polar solvent) carrier vehicle (e.g. a boiling point of 100° C. or less) so as to obtain a reformation treatment agent impregnated material (e.g. water, acetone, etc.). The fluid (polar solvent) carrier vehicle may thus be a fluid as described above with respect to the dehydration step or stage.

The reformation stage treatment agent impregnation treatment may thus in particular also comprise the use of an acidic (inorganic) phosphorous compound using a polar solvent as fluid carrier such as water or and (low boiling point) organic solvents such as suitable ketones, alcohols etc. such as methanol or acetone. Thus phosphoric acid technical reagent grade, 85%, density 1.685 gram/cc may be used to impregnate a cellulose-based precursor in association with a solvent such as methanol, acetone, etc. The solvent may also advantageously be an organic solvent such as a lower alcohol for example methanol.

The reformation treatment agent impregnation step includes a drying step comprising driving off the low boiling point fluid carrier so as to obtain a dry dehydration agent impregnated material at least essentially free of said fluid carrier.

The aromatized material obtained directly from the aromatization step or an reformation treatment agent impregnated aromatized material obtained from the drying step mentioned above may thereafter be subjected to a heating step comprising heating the aromatized material, in an oxidation-suppressing environment (e.g. atmosphere such as an inert gas such as for example, nitrogen, helium or argon), (e.g. in the presence of a volatilized (acidic) reformation treatment agent derived from an independent or discrete source) at a temperature above 650° C. (e.g. a temperature above 700° C. in particular for example in the range of from 700° C. to 1000° C.) [in this temperature range pyrophosphoric acid is believed to be transformed to metasphosphoric acid and the latter is believed to be volatilizable at temperatures greater than 700° C.—see FIG. 16] for a time period sufficient so as to obtain a carbonized material. The heating may occur in a suitably configured oven in an oxidation-suppressing atmosphere (see for example FIGS. 1a and 1c).

If desired or necessary the obtained activated carbon product may be cooled and subjected to a polar solvent washing step wherein the reformation treatment stage agent as well as by-product materials associated with said activated carbon product is/are washed from said activated carbon product. The polar solvent may be acetone or advantageously methanol or ethanol due to their lower boiling point The so washed product may then be (air) dried at room temperature over a suitable period of time so as to obtain a (solvent) dried product.

Thus more particularly, the aromatized precursor product may be used ‘as is’ or water washed for the reformation stage. In both instances, the aromatized char may be submerged in a solution of concentrated phosphoric acid in acetone (10 to 40 grams/100 ml methanol, and preferably 35 grams/100 cc methanol) for three minutes and may be air dried at room temperature in a well ventilated booth overnight. More advantageously, the sample may be more homogeneously impregnated by using the procedure described earlier. The impregnated aromatized char may contain 40 to 60% phosphoric acid on a weight basis i.e. w/w. The acid treated intermediate may then be mounted in a high temperature oven and heated at 700° C. to 1000° C. and more advantageously at 850° C. for 10 to 45 minutes and preferably for 15 minutes under an inert gas (nitrogen, helium, or argon) at 50 to 100 ml/minutes and advantageously at 70 to 80 ml/minute. It should be noted that as in the case for the aromatization stage the acid treated precursor may be preceded (see FIG. 1b) by a similarly (phosphorous) impregnated (porous) treated graphite felt upstream of the inert gas flow to effectively replenish the acid lost during the process otherwise the product may have a relatively low BET e.g. less than 500 m²/g. The final product may be washed essentially free of acid with water and dried in an oven at 100° C. for one or more hours. The yield of Elevated Temperature Char ranges from 30 to 36% (theoretical 38%).

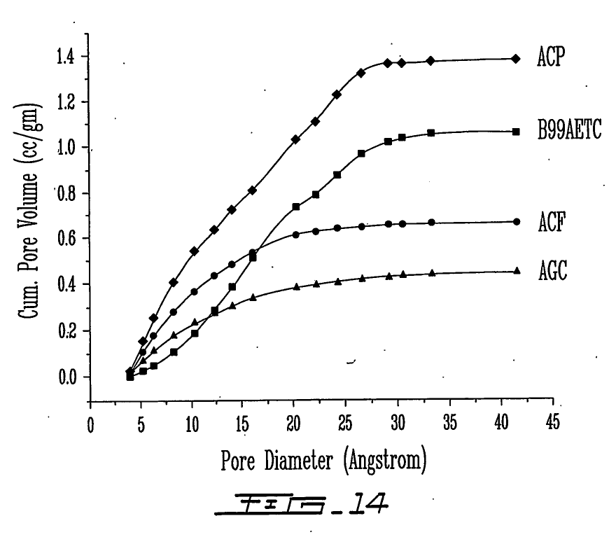

The washed elevated temperature char may have a specific area of greater than 1900 m²/g (e.g. greater than 2300 m²/gram), a high bulk density—at least 80% of the respective precursor material (e.g.>0.15 gram/cc) and a resistivity of less than 55 ohm-cm as such, the product may be advantageously electrothermally regenerated. Its porosity may range from 5.0 to 50.0 angstroms pore width with a significant surface area found in the 15 to 35 angstroms pore width. Its pore volume may be greater than 60% and even 80% for pores greater than 10 angstroms in size. The total pore volume may be greater than 1.0 cc/g and its micropore volume may be 0.7 cc/g. The pore volume distribution is physically different from other known activated carbons (See FIG. 13). Its measured adsorptive capacity for toluene may be 600 to 800 mg/gram and it may be 400 to 600 mg/gram for carbon tetrachloride. The average elemental composition for this product is: carbon: 98.4%, and H: 1.57%.

In drawings which illustrate example embodiments of the present invention

FIG. 1 schematically illustrates an example gas flow through oven arrangement for the dehydration and carbonization stages

FIG. 1a schematically illustrates an example gas flow through oven arrangement for the aromatization and activation (or reformation) stages

FIG. 1b schematically illustrates an example tubular holder for supporting carbon precursor transversely across a gas flow path for the passage of gas through said carbon precursor (i.e. such gas passing from said gas intake side to said gas discharge side passes through said precursor);

FIG. 1c schematically illustrates by way of an example the incorporation of a holder structure illustrated in FIG. 1b into oven housing

FIG. 1d schematically illustrates an alternate oven arrangement wherein there is no gas flow through but a discrete source of volatilized treatment agent is present;

FIG. 1e schematically illustrates an example arrangement for determining the resistivity of a disk shaped (activated) carbon sample material in accordance with the resistivity formula given above; in other words a char sample electrical resistivity measurement is taken between the uncompressed sample's top and bottom distance A for a diameter of B (at room temperature of e.g. 22C.)

FIG. 1f schematically illustrates an further example tubular holder for supporting carbon precursor transversely across a gas flow path for the passage of gas through said carbon precursor (i.e. such gas passing from said gas intake side to said gas discharge side passes through said precursor);

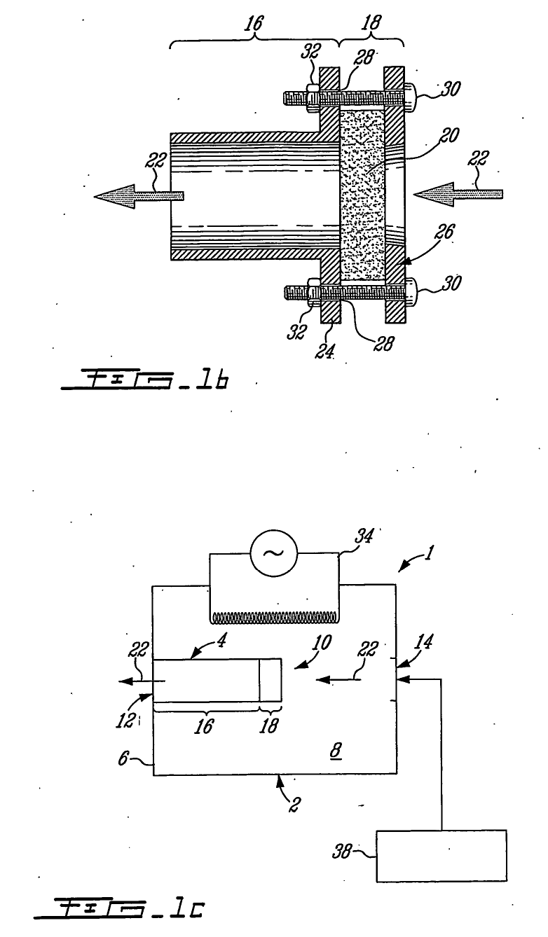

FIG. 2a shows loss of weight of a cellulose-based sample during heat treatment, namely, precursor cumulative weight loss during charring (sample treated with a 10% w/v phosphoric acid solution);

FIG. 2b shows loss of weight of a viscose rayon sample during heat treatment, namely viscose rayon precursor weight loss during charring (sample treated with a 10% w/v phosphoric acid solution);

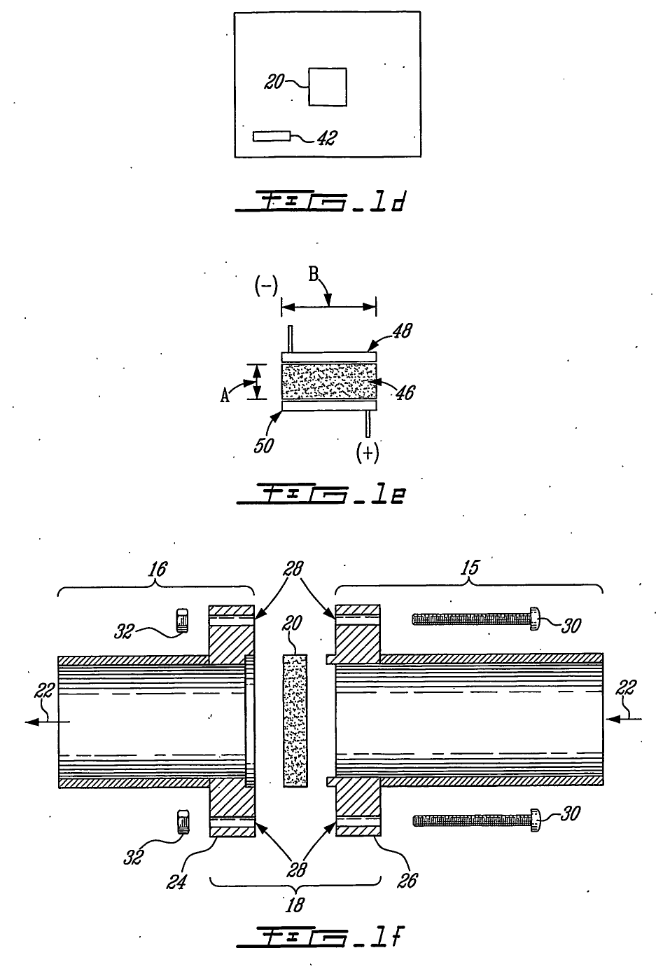

FIG. 3 shows effect of concentration of phosphoric acid added to cotton (denim) on yield of Low temperature Char (LTC) prepared by heating the precursor at 142° C. over a 24 hour period under nitrogen;

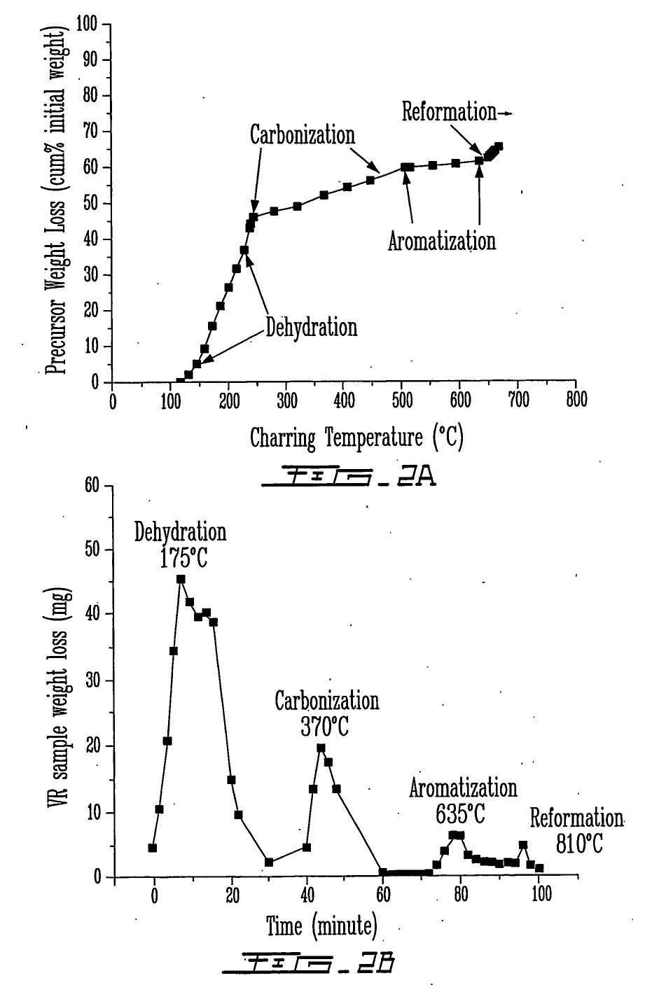

FIG. 4 shows Low temperature Char (LTC) yield obtained from viscose rayon impregnated with phosphoric acid in methanol after heating at 150 C 24 hours in air;

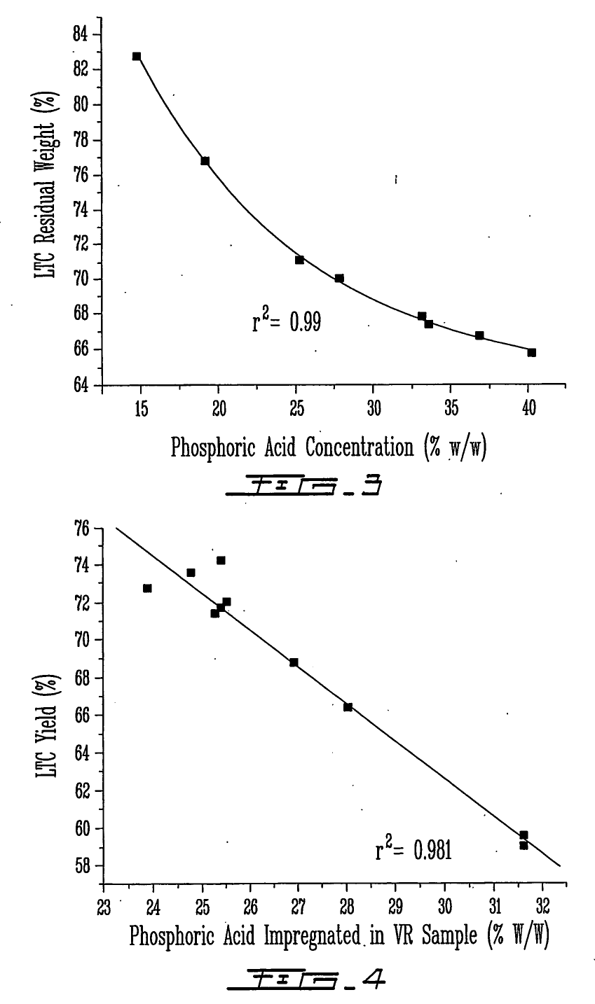

FIG. 5 demonstrates the effect of temperature on the yield of Low temperature Char obtained from cotton impregnated with 30-37% w/w phosphoric acid after heating for 24 hours under nitrogen;

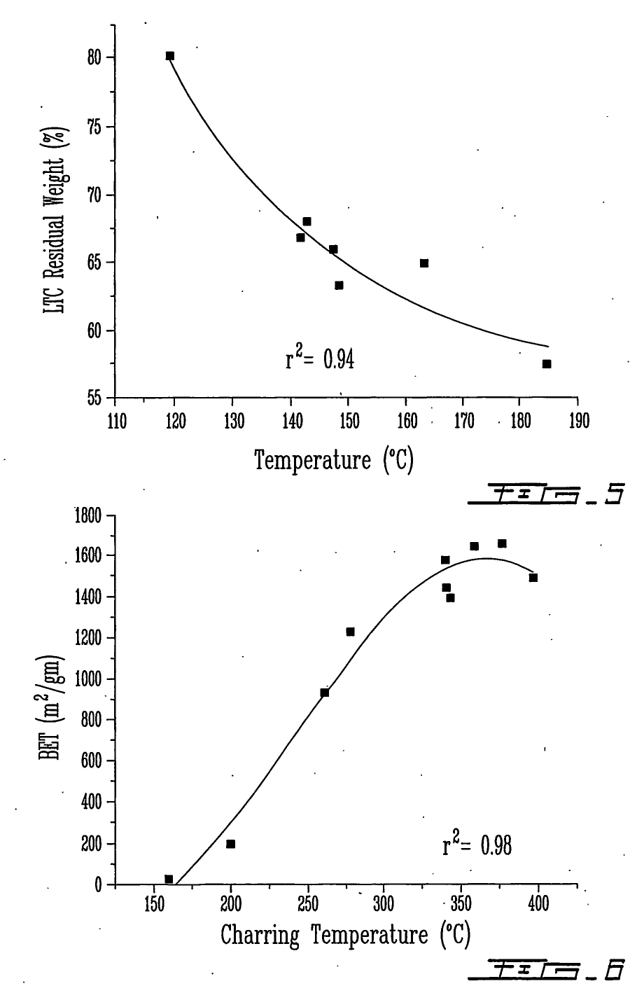

FIG. 6 demonstrates the effect of charring temperature (10 minute duration) on the adsorptive capacity of Medium temperature Char (MTC) with 30-37% w/w phosphoric acid added to low temperature char;

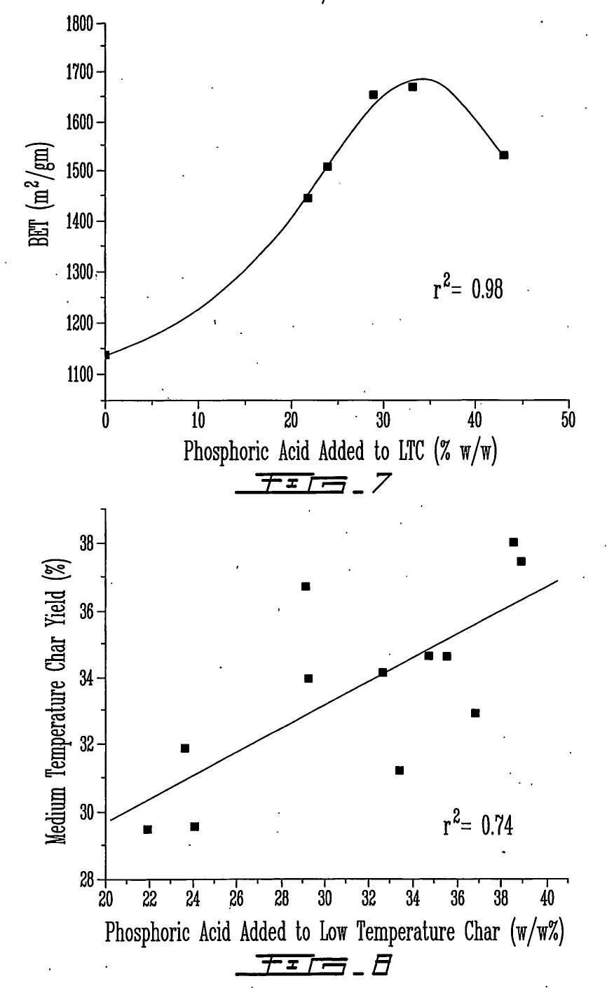

FIG. 7 demonstrates effect of phosphoric acid added to low temperature char (LTC) on the BET value of Medium temperature Char (MTC) with charring time of 10 minutes and char temperature of 358-376° C.,

FIG. 8 shows effect of phosphoric acid added to the Low Temperature Char (LTC) on the yield of Medium Temperature Char (MTC) with tests conducted at 332-400° C., 10 minutes under nitrogen;

FIG. 9 pore volume distribution of a medium temperature char;

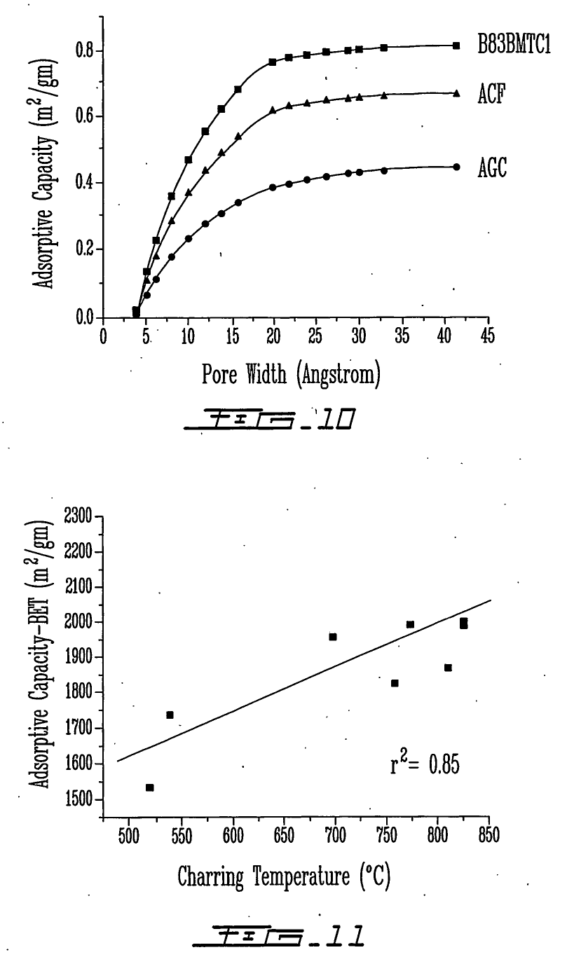

FIG. 10 comparison of the pore distribution for a Medium Temperature Char (B83BMTC1) with that of a commercial activated carbon felt (ACF) and activated granular carbon (AGC);

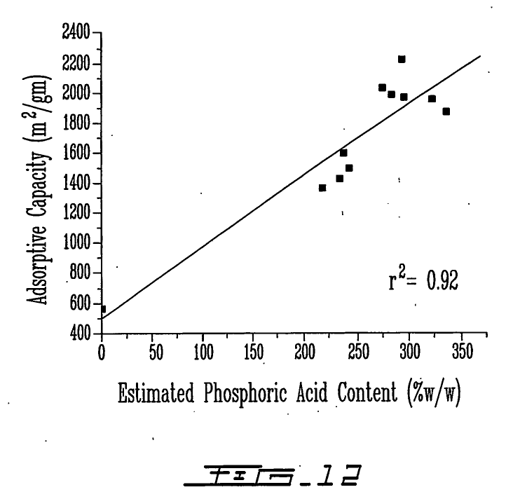

FIG. 11 illustrates the impact or influence of charring temperature on the adsorptive capacity of high (HTC) and elevated (ETC) temperature chars with heat treatment duration 20 minutes under nitrogen;

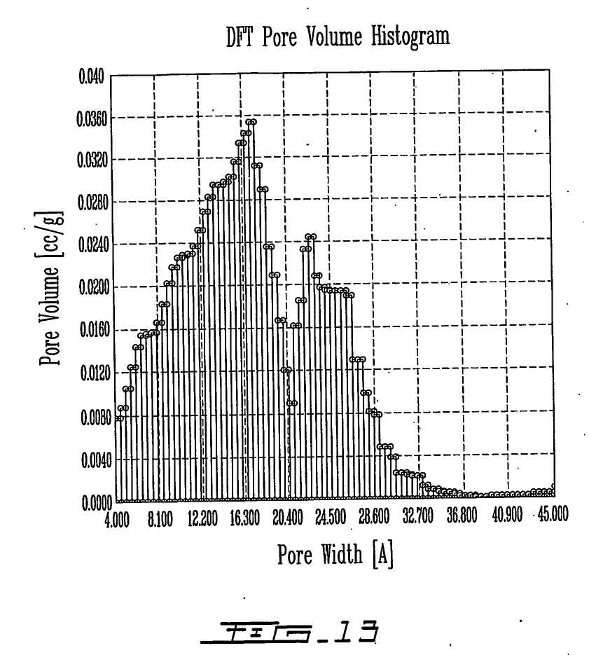

FIG. 12 the effect of estimated phosphoric acid content of Elevated temperature Char on adsorptive capacity (BET), with charring temperature 750-850° C., 20 minutes under nitrogen;

FIG. 13 pore volume distribution of an elevated temperature char,

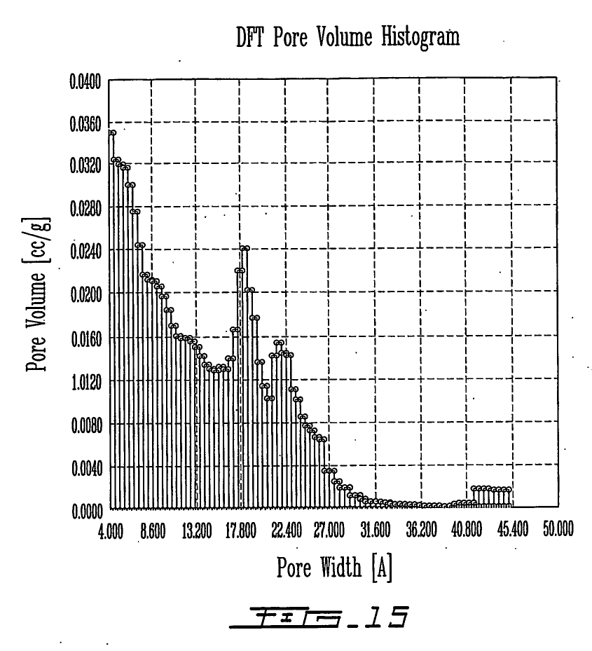

FIG. 14 pore volume comparison for commercial activated carbon powder (ACP), an elevated temperature char (B99AETC), activated carbon felt (ACP) and activated carbon granules (AGC);

FIG. 15 pore volume distribution of an High Temperature Char; and

FIG. 16 Weight loss associated with heating phosphoric acid at 3 C/minute under 85 cc/minute nitrogen flow rate.

Referring to FIGS. 9, 13 and 15 the parameters for the assays were as follows:

FIG. 9
Sample description B83BMTC1
Comments Prepared at 376° C.
Outgas temperature 200.0° C.
Outgas time 2.0 hrs
Analysis time 162.6 min
Operator J. P. Farant

FIG. 13
Sample description B99AETC
Comments ETC heated under He to 778° C.
Outgas temperature 200.0° C.
Outgas time 2.0 hrs
Analysis time 192.1 min
Operator J. P. Farant

FIG. 15
Sample description B96BHTC2
Comments HTC heated at 538° C. under nitrogen
Outgas temperature 200.0° C.
Outgas time 2.0 hrs
Analysis time 155.6 min
Operator J. P. Farant

Referring to FIGS. 1 through 1c, these figures schematically illustrate an example configuration(s) of a gas flow through oven for the heat treatment of a carbon precursor of fibrous, fluid porous (e.g. textile like) structure, e.g. a disk shaped (non-woven) felt material. The same reference numerals are used to refer to common features or elements.

The oven 1 has an outer housing 2. Referring in particular to FIG. 1c, the oven 1 has a tubular gas path component 4 defining a gas flow path which passes through a side wall 6 of the housing 2 into the interior 8 of the oven housing 2. The tubular gas path component 4 has a gas inlet 10 disposed within the oven housing 4 and a gas outlet 12 extending out said side wall 6 of the housing. The housing 2 has a gas inlet 14 for the introduction of gas into the interior 8 of the housing 2 The tubular gas path component 4 has a gas intake side in gas communication with the interior 8 of the housing 2 and a gas discharge side 16 in gas communication with the gas outlet 12. For the embodiment shown the gas inlet 10 and the gas intake side (ie. element 18 of the embodiment shown in FIG. 1c) of the gas path component 4) are more or less coterminous; if desired or necessary the gas intake side could have an extended aspect (see for example FIG. 1f). The tubular gas path defined by the gas path component 4 may have any desired cross-section (e.g. circular, square, etc.). The tubular gas path component 4 has a precursor support component 18 for supporting a carbon precursor 20 (e.g. of woven or non-woven structure—see FIG. 1b) transversely across the gas flow path for the passage of gas through said carbon precursor (i.e. in the direction of the arrow 22).

Referring to FIGS. 1 and 1b, the precursor support component 18 may have a pair of opposed ring like clamping ring structures 24 and 26 which have peripherally disposed fastener holes 28 and which may be connected together thereby by bolt and nut fastener combinations (indicated by the general reference numerals 30 and 32) so as to clamp or sandwich the periphery of the precursor 20 there between. As mentioned a gas may for example be allowed to flow through the so defined gas path transversely to the precursor 20 in the direction of the arrow 22.

Referring back to FIG. 1c, the oven is provided with an electrical heating component 34 for subjecting the precursor 20 to a heat treatment. As may be understood the heating component 34 is so configured and disposed within the oven housing for heating gas passing through the oven interior 8 to the gas inlet 10 of the to a predetermined or desired heating temperature prior to passage of the gas through the carbon precursor 20. The heating system shown also has a source of gas 38 (e.g. a high pressure gas storage tank or gas (e.g. air) pump) able to urge gas though the gas passageway.

Referring to FIG. 1a, this figure shows the use of the holder of FIG. 1 for the disposition of a discrete source of treatment agent upstream of the carbon precursor, namely a similarly configured porous graphite pad 40 impregnated with a desired (volatilizable) treatment agent in abutting contact with the carbon precursor 20. The graphite pad 40 could of course be supported so as to be upstream of the carbon precursor but spaced apart from the carbon precursor. Alternatively, treatment agent may be volatilized at a separate volatilization unit and fed into the upstream gas path by suitably disposed tubing.

Referring to FIG. 1d, this figure schematically illustrates an oven structure with no gas flow through for operation at atmospheric pressure but provided with a discrete source of treatment agent therein which may also take the form of a suitably impregnated (suspended) graphite pad 42 disposed to one side of a carbon precursor 20.

Referring to FIG. 1e, it schematically illustrates an example arrangement whereby the resistivity of a circular (e.g. activated) carbon felt pad 46 may be ascertained by connection of electrodes of an (known) ohm or multi-meter (not shown) to the disk pad plate electrodes 48 and 50 which sandwich the (activated carbon) felt pad 46 there between as shown without compression of said felt pad, the activated carbon pad 46 having a thickness A, and a diameter B. For the illustrated embodiment the resistance may be measured across A, i.e. across the body of the activated carbon pad which is disposed transversely across the gas flow path of the above described heat treatment oven system. The distance A may for example be 1 cm. The relationship used to calculate the resistivity is there after calculated using the resistivity formula given above. All measurements were conducted at room temperature (e.g. at a temperature of 22 C).

An oven arrangement as illustrated in FIGS. 1 through 1c was used for the following examples. The resistivity was determined as described with respect to FIG. 1e.

For the following examples reference will be made to the following, namely:
Density Functional Theory (DFT):
A known procedure used for the derivation of the pore size distribution in a adsorbent material from its adsorption isotherm data; i.e. a procedure for evaluating pore size distribution:
   and
MP (Micropore) Analysis:
A known micropore analysis method which allows the determination of micropore volume, surface area and their distributions from one experimental isotherm. The method is applicable to adsorbents having Macropores, mesopores and micropores.

### EXAMPLE 1

Preparation of a Low Temperature (e.g. <200° C.) Char (Dehydration Stage) from Viscose rayon felt.

A, piece of viscose rayon felt (18×18×1.8 cm) un-dyed and non-finished supplied by American NonWoven having an estimated bulk density of 0.245 g/cc and weighing 64.15 grams was dipped for 90 seconds in a shallow polyethylene pan containing an impregnation solution consisting of 120 grams of phosphoric acid (85% w/v, Fisher Scientific) in one litre of methanol (10.2% phosphoric acid w/v). The sample was removed from the impregnation solution, the excess removed by passing the sample through a roller wringer and it was fixed to a rotating platform (Fisher Scientific Chemistry Mixer Model 346) and allowed to dry at room temperature in a fume hood for 6 hours for the removal of methanol. The impregnated sample weighed 82.11 grams (28.0% phosphoric acid w/w (i.e. weight of phosphoric acid per weight of sample used for this example)).

The phosphoric acid impregnated sample was then placed in a holder (see FIG. 1) and charred at 150° C. in air for 24 hours.

The Low Temperature Char weighing 50.17 grams was washed five times by placing it in a one litre vessel containing 800 cc of deionised water in a ultrasonic bath for 30 minutes. The sample was then dried in air in an oven at 100° C. for four hours.

The highly flexible, tear resistant, lustrous sample weighed 42.85 grams (66.8% residual weight). Its BET (surface area) (six point BET) of 32.1 m²/gram was determined on a Quantachrome Autosorb Automated Gas Sorption instrument model 1200 with nitrogen. Its elemental composition was carbon: 69.5%, H, 2.7%, and O: 27.8%. Its bulk density was estimated to be 0.225 g/cc.

### EXAMPLE 2

Preparation of a Medium Temperature (e.g. 250-400° C.) Char (Carbonization Stage) from Viscose Rayon Felt.

The washed Low Temperature Char prepared in example 1 was dipped in an impregnation solution consisting of 220 grams of phosphoric acid (85% w/v, fisher Scientific) in one litre acetone for 3 minutes with frequent turning and tamping to ensure uniform impregnation of the acid. The impregnated sample was allowed to drain off its excess impregnation solution and fixed to the platform of a horizontally rotting mixer and left to dry at room temperature in a fume hood for six hours for the removal of acetone.

The impregnated sample weighed 57.29 grams (33.8% phosphoric acid w/w (i.e. weight of phosphoric acid per weight of sample used for this example)).

Note that the non-washed Low Temperature Char could have been subjected to this acid impregnation step with similar results. Note also that a more homogeneous impregnation of the sample could have been obtained by allowing the impregnation solution to percolate through the sample for a suitable period of time (e.g. one hour or less) and flash filtration of the remaining impregnation solution.

The acid impregnated Low Temperature Char was placed in an holder (FIG. 1) and heated under nitrogen, flow rate 154 cc/minute, at 345.7±7.1° C. for 15 minutes.

The obtained Medium Temperature char was washed five times with deionised water in an ultrasonic bath as describe above in example 1. It was then dried in air in an oven at 100° C. for two hours.

The spongy, flexible, tear resistant Medium Temperature Char weighed 27.00 grams (42.1% residual weight). Its BET (surface area)—(six point BET) was 1449 μm²/gram. The Density Function Theory (DFT) pore volume distribution was also obtained on the Quantachrome instrument with nitrogen. It showed a char whose pores (as indicated by its pore volume distribution) are essentially below 20 angstroms in size and preponderantly <10 angstroms. The microporous nature of this chat is confirmed by the Langmuir isotherm and the Alpha-s data which gave a micropore volume of 0.543 cc/gram. According to a (MP) method micropore analysis, its total pore volume is 0.761 cc/gram. Its adsorption capacity for toluene was evaluated at 262.7 milligram/gram at 53.1% relative humidity, 21.9° C. and 108 cc/minute flow rate. This char's bulk density is estimated at 0.203 gm/cc. Its resistivity was measured as described (FIG. 1e) at 3.8 megaohms-cm.

The char's elemental composition is carbon: 91.5%, H, 2.67%, and O: 5.83%

### EXAMPLE 3

Preparation of a High Temperature (e.g. 500-650° C.) Char (Aromatization Stage) from Viscose Rayon Felt.

The Medium Temperature Char in example 2 was dipped in an impregnation solution containing 321.5 grams of phosphoric acid (85% w/v) in one litre of acetone for 3 minutes with frequent turning and tamping. The excess impregnation solution was allowed to drain from the sample during a five minute period. It was then fixed to the platform of a rotating mixer and allowed to dry at room temperature in a fume hood for six hours for the removal of acetone. The acid impregnated sample weighed 45.3 grams (67.7% phosphoric acid w/w (i.e. weight of phosphoric acid per weight of sample used for this example)).

A same size graphite felt pad one centimetre thick provided by National Carbon was similarly treated (i.e. impregnated).

Both acid impregnated materials were placed in a holder (FIG. 1b) with the graphite pad placed in front (i.e. upstream) of the acid impregnated Medium Temperature Char in such a way that the nitrogen gas would first pass through the graphite before it, thus replenishing the acid loss by the sample during the high temperature treatment.

The tandem samples were heated at 538.4±3.1° C. under a 142 cc/minute nitrogen flow rate for a period of 20 minutes. Note that the non-washed Medium Temperature Char prepared in example 2 could have been used with essentially the same results.

The product of this process was washed five times with deionised water in an ultrasonic bath as described in example 1 and dried for two hours at 100° C.

The High Temperature Char weighed 20.46 grams (31.9% residual weight) and was spongy, lustrous and tear resistant. Its surface area determined with nitrogen on the Quantachrome autosorb was 1814 m²/gram. Its resistivity was 31.8 kilo Ohms-cm. (The resistance was measured by multimeter—ohm meter using the set-up in FIG. 1e, the resistivity being calculated using the above described formula).

A DFT pore volume distribution, MP method micropore analysis, langmuir isotherm plot and Alpha-s analysis were performed on the High Temperature Char using the Quantachrome Autosorb instrument and nitrogen. This analysis reveals a significant growth in pores with diameters >20 angstroms and a clear diminution of those pores with diameters <10 angstroms (see example FIG. 15 and table 3). This is attested to by the Langmuir isotherm and the Alpha-s data which gives a micropore volume of 0.722 cc/gram and the MP analysis which shows a total pore volume of 0.886 cc/gram. Its adsorptive capacity for toluene was 486 milligram/gram at 63% relative humidity 22° C. and 112 cc/minute flow rate. The char's bulk density was estimated at 0.188 gram/cc. The char's elemental composition is: carbon: 95.4%, H, 2.02%, and O: 2.03%.

### EXAMPLE 4

Preparation of an Elevated Temperature (e.g.>650° C.) Char (Pyrolytic Reformation Stage—Tempering from a High Temperature Char)

The High Temperature Char whose preparation is described in example 3 was dipped in an impregnation solution consisting of 360.0 grams of phosphoric acid (85% w/v) in one litre of acetone for 3 minutes with frequent turning and tamping to ensure homogeneous impregnation of the acid. The excess impregnation solution was allowed to drain from the sample for five minutes and it was then mounted on a rotating mixer for 6 hours at room temperature in a fume hood for solvent removal. The acid impregnated sample weighed 30.88 grams (50.9% phosphoric acid w/w (i.e. weight of phosphoric acid per weight of sample used for this example)). A similar size graphite felt pad 1 cm thick was similarly treated (see example 3). Both acid impregnated material were placed in a holder (FIG. 1c) with the acid impregnated graphite pad placed upstream of the acid impregnated High Temperature Char. The tandem samples were heated at 771.3±8.0 C for 15 minutes under a nitrogen flow rate of 74.6 cc/minute. Note that the non-washed High Temperature Char in example 3 could have been used with essentially the same results.

The Elevated Temperature Char obtained was washed five times with deionised water in an ultrasonic bath as described in example 1 and dried for two hours at 100 C.

The Elevated Temperature Char weighed 19.8 grams (30.8% residual weight), and had a BET (Surface area) of 2229 m²/gram. The Density Function Theory (DFT) pore volume distribution, MP method micropore analysis, Langmuir isotherm plot and Alpha-s data were also obtained with a Quantachrome instrument using nitrogen. The analysis revealed a dramatic growth in the number of pores whose diameter is >20 Å and a significant reduction in micropores whose diameter is <10 Å. (See for example FIG. 13 and table 3). Its Total Pore Volume is 1.12 cc/gram and its micropore volume is 0.754 cc/gram. Its adsorptive capacity for toluene was measured at 524 mg/gram at 73.5% relative humidity, 22.4 C and 107 cc/minute flow rate. The char's bulk density was estimated at 0.176 gram/cc. Its resistivity was 20.6 Ohms-cm. The char's elemental composition is: carbon: 98.6% and H: 1.4%.

### EXAMPLE 5

Preparation of an Elevated Temperature (>650° C.) Char (Pyrolytic Reformation Stage) Directly from a Dehydrated Viscose Rayon Material

This example will illustrate the preparation of an Elevated Temperature Char from Medium Temperature char starting from a dehydrated viscose rayon felt.

A piece of viscose rayon felt (18×18×1.8 cm) un-dyed and non-finished supplied by American Non Woven having an estimated bulk density of 0.236 g/cc and weighing 59.63 grams was dipped for 90 seconds in a shallow polyethylene pan containing the impregnation solution of 170.0 grams of phosphoric acid (85% w/v) in one litre of acetone (14.45% phosphoric acid w/v). The impregnated sample was treated essentially as described in example 1. The impregnated sample weighed 86.12 grams (44.4% phosphoric acid w/w (i.e. weight of phosphoric acid per weight of sample used for this example)).

The phosphoric acid impregnated sample was then placed in a holder (FIG. 1) and heated at 161.5° C. under nitrogen at a flow rate of 125 cc/minute for 23 hours.

The unwashed Low Temperature Char obtained weighing 57.87 grams was then dipped in a solution containing 220 grams of phosphoric acid (85% w/v) in one litre of acetone (18.7% phosphoric acid w/v) for 3 minutes with frequent turning and tamping.

This acid impregnated sample which weighed 92.73 grams was placed in a holder (FIG. 1). A piece of graphite felt (18×18×1 cm, National Carbon Corp.) weighing 66.84 grams was dipped in a solution of 160 grams phosphoric acid (85% w/v) in one litre of acetone (13.6% phosphoric acid w/v) in a shallow plastic pan for 3 minutes with frequent turning and tamping. This acid impregnated graphite felt which was impregnated using the same method as described for the Low Temperature Char weighed 162.4 grams (142.9% w/w). It was also placed in the holder upstream of the unwashed acid impregnated Low Temperature Char to ensure that the acid loss from the latter during its high temperature treatment would be essentially replenished. These tandem samples were heated under nitrogen, flow rate of 154 cc/minute at 345.7±7.1° C. for 15 minutes and subsequently heated at 754.2±6.7° C. for 10 minutes under nitrogen at a flow rate of 52.4 cc/minute.

The resulting unwashed Elevated Temperature Char obtained weighed 90.85 grams and the graphite felt weighed 100.8 grams. The Elevated Temperature Char was washed five times with distilled water in an ultrasonic bath as described in example 1 and dried for two hours at 100° C.

The washed and dried Elevated Temperature Char weighed 21.58 grams (36.2% yield; theoretical yield 38%). It was spongy, lustrous, dense and tear resistant. Its surface area determined with the Quantachrome Autosorb and nitrogen was 1826 m²/gram and its resistivity was 33.4 Ohms-cm and, as such, it may be electrothermally regenerated.

The DFT pore volume distribution, Alpha-s test, Langmuir isotherm plot and MP method analysis all concur to indicate that this char was markedly less microporous than lower temperature chars (see example FIG. 13). Thus, it is believed that pores whose diameter are <10 Å have completely lost their previous pre-eminence and have been replaced by pores whose diameter ranges from 14-18 Å. Pores whose diameter is >20 Å have gained significantly in number. The Langmuir isotherm shows a distinctive increase in mesopores. According to the Alpha-s data the micropore volume is 0.753 cc/gram and the MP analysis indicates a total pore volume of 0.915 cc/gram. The char's adsorptive capacity for toluene is evaluated at 657 milligram/gram at 58.7% relative humidity, 20.9° C. and 123 cc/minute flow rate. The char's bulk density is estimated to be 0.185 gram/cc. Its elemental composition was: carbon: 98.0%, and H, 1.98%.

### EXAMPLE 6

Preparation of an Elevated Temperature Char from the Viscose Rayon Precursor Without Pre Impregnation of the Low Temperature Char with Phosphoric Acid.

This example illustrates the preparation of an Elevated Temperature Char from viscose rayon felt in two steps namely, dehydration, carbonisation and pyrolytic reformation and where the non washed Low Temperature Char was not (further) impregnated a priori with phosphoric acid for the heat treatment. Phosphoric acid was provided to the Low Temperature Char via its volatilization from a graphite felt impregnated with acid during the process.

A sample of viscose rayon (18×18×1.8 cm) un-dyed and non-finished supplied by American NON Woven and weighing 61.16 grams was dipped for 90 seconds in a solution of 170.0 grams phosphoric acid (85% w/v) in one litre of acetone (14.45% phosphoric acid w/v) contained in a shallow polyethylene pan. The impregnated sample was treated essentially as described in example 1. The impregnated sample weighed 87.88 grams (43.7% phosphoric acid w/w (i.e. weight of phosphoric acid per weight of sample used for this example)). The phosphoric acid impregnated sample was placed in a holder (FIG. 1) and heated at 161.1° C. for 24 hours.

The Low Temperature Char weighing 60.66 grams was placed in a holder (FIG. 1) downstream from a piece of graphite felt impregnated with phosphoric acid as described in example 5. The tandem samples were heated to 346° C. at a rate of 5° C./minute and held at this temperature for 10 minutes under a helium flow rate of 43 cc/minute. The samples were then heated to 785° C. at a rate of 9° C./minute and held at this temperature for 15 minutes under a helium flow rate of 56 cc/minute.

The washed Elevated Temperature Char weighed 16.62 grams (27.2% yield). Its surface area determined with the Quantachrome Autosorb and nitrogen was 1749 m²/gram and its electrical resistivity was 25.9 Ohms-cm an, as such, it can be electrothermally regenerated. Its other properties are similar to that of the chars obtained in examples 4 and 5.

### EXAMPLE 7

Preparation of a Medium Temperature Char from a Lower Temperature Char (Obtained A Priori from a Treatment Viscose Rayon Cloth with Phosphoric Acid as Described Above) with Boric Acid.

This example demonstrates the preparation of a Medium Temperature Char from a viscose rayon cloth based Lower Temperature Char using an alternative reagent, boric acid. Note that attempts to prepare a Lower Temperature Char from a starting carbon material treated solely with boric acid did not result in a dehydrated product.

A 13.5 cm diameter sample of viscose rayon cloth was soaked in a solution of 12.0 g of phosphoric acid in methanol for 5 minutes, then allowed to dry at room temperature overnight to give a sample impregnated with 25% w/w phosphoric acid (i.e. weight of phosphoric acid per weight of sample used for this example)). The impregnated sample was heated in air at 160° C. for 24 hours giving a 79.9% yield after repeated water washes.

The Lower Temperature Char so obtained was subsequently treated as described with a solution of 15.0 g of boric acid in 150 cc of boiling methanol giving a 21% boric acid w/w (i.e. weight of boric acid per weight of sample used for this example)) boric acid impregnated sample. The sample was then placed in a sample holder and heated at 375° C. for 45 minutes under a nitrogen gas flow of 140 cc/min. The sample was repeatedly water washed to yield 41% of a Medium Temperature Char having a BET of 418 m²/g. It is noteworthy that this sample has an enhanced tensile strength as compared to similar samples prepared with phosphoric acid.

A combination of the two acids was used to prepare a medium temperature char in 33% yield and having a BET of 1320 m²/g and a Butane number of 33.4 g butane pre 100 g sample.

### EXAMPLE 8

Preparation of Chars from a Denim Cotton Precursor.

This example will demonstrate that Lower, Medium and Elevated Temperature Chars can be prepared using slight modification of the procedure described for a viscose rayon precursor.

A 13.5 cm sample of cotton denim was soaked in a solution of 15 g of phosphoric acid in 100 cc of methanol for five minutes then allowed to dry at room temperature overnight. The acid impregnated sample 18.8% phosphoric acid w/w (i.e. weight of phosphoric acid per weight of sample used for this example)) was heated at 160° C. in air for 20 hours. The dark brown char was repeatedly water washed yielding 64.6% of a char with a remarkable tensile strength.

The char obtained was then treated with 15.0 g of boric acid in 150 ml of hot methanol as described above to give a char with 31% w/w boric acid w/w (i.e. weight of boric acid per weight of sample used for this example)). It was placed in a sample holder and heated under nitrogen (145 cc/min) at 375° C. for 45 minutes. The product was repeatedly water washed and yielded 38.1% of a Medium Temperature Char having a BET of 757 m²/g.

In a separate trial, a sample of cotton denim was soaked in a solution of 33% phosphoric acid (w/v) in acetone and allowed to dry at room temperature. The acid impregnated sample was heated at 143° C. in an oven for 17 hours under nitrogen yielding 68.0% of a high quality Lower Temperature Char. The latter was soaked in a solution of 23.4% phosphoric acid in acetone (w/v) and allowed to dry at room temperature overnight. It was then heated under nitrogen gas to 347° C. and held at that temperature for 20 minutes then the temperature was increased to 805° C. and held there for a further 20 minutes. The product was repeatedly water washed yielding 28.1% of an Elevated Temperature Char having a BET of 1200 m²/g and a resistivity <50 Ohms-cm.

### EXAMPLE 9

Preparation of Chars from Coconut Using Slight Modification of the methodology Developed for Viscose Rayon.

Crushed Coconut Shell Medium Temperature Char.

5.0 g of a crushed coconut shell sample was placed in a solution of 50% (w/v) phosphoric acid in methanol and allowed to soak at room temperature for several days. The impregnation solution was decanted and the acid impregnated granules (35.0% phosphoric acid w/w (i.e. weight of phosphoric acid per weight of sample used for this example)) dried. The sample was then charred in air at 161.5° C. for 24 hours; water washed repeatedly yielding 82.9% of a homogeneously black Lower Temperature Char.

The Lower temperature Char was then treated with a solution of 45% w/v phosphoric acid in methanol for 48 hours at room temperature giving a 40% phosphoric acid w/w (i.e. weight of phosphoric acid per weight of sample used for this example)) impregnated sample. The sample was placed in a holder and heated under nitrogen at 375° C. for 45 minutes, water washed repeatedly and dried yielding 39.7% of a Medium Temperature Char with a BET of 898 m²/g.

### EXAMPLE 10

Preparation of Medium Temperature Char Directly from Phosphoric Acid Impregnated, Non-dehydrated viscose rayon.

This example will demonstrate the undesired results of treating a non-dehydrated viscose rayon material; impregnating with phosphoric acid, directly using medium temperature char conditions.

A 13.5 cm sample of viscose was soaked in a solution of 12 g of phosphoric acid in 100 cc of methanol for five minutes then allowed to dry at room temperature overnight. The acid impregnated sample 44.1% phosphoric acid w/w (i.e. weight of phosphoric acid per weight of sample used for this example)) was heated at 375° C. for 45 minutes in a flow of 150 cc/min of nitrogen gas in a furnace set-up analogous to that illustrated in FIGS. 1-1F and then allowed to cool to room temperature (e.g. to a temperature of 22 C). The activated carbon char was washed five times in de-ionized water yielding 33.2% of a char with poor physical properties (i.e. the sample easily crumbled when manipulated). The char had a marginal butane number of 20.7 g butane/100 g of sample and an average BET value of 870 m²/g.

### EXAMPLE 11

Preparation of Medium Temperature Char directly from a Non-Dehydrated Viscose Rayon Material Impregnated with Both Phosphoric Acid and Boric Acid.

This example will demonstrate the undesired results obtained from impregnating a non-dehydrated viscose rayon material; impregnated with both phosphoric acid and boric acid, directly using medium temperature char conditions.

A 13.5 cm sample of viscose was soaked in a solution of 15 g of phosphoric acid and 5 g of boric acid in 100 cc of methanol for five minutes then allowed to dry at room temperature overnight. The acid impregnated sample, 64.1% phosphoric acid and boric acid w/w (i.e. weight of phosphoric acid and boric acid combined per weight of sample used for this example)) was heated at 375° C. for 45 minutes in a flow of 150 cc/min of nitrogen gas using a furnace set-up analogous to that illustrated in FIGS. 1-1F and then allowed to cool to room temperature (e.g. to a temperature of 22 C). The activated carbon char was washed five times in de-ionized water yielding 24.49% of a char with poor physical properties (i.e. the sample easily crumbled when manipulated, shredded and broke into fragments easily). The char had a marginal butane number of 22.98 g butane/100 g of sample and an average BET value of 937 m²/g.

The preparations detailed above demonstrate that the methodology developed for viscose rayon can be applied to other cellulosic precursors.

The following comments represent the present understanding of the activation process(es).

As may be surmised from the above examples, chemical activation of a cellulosic material may produce a variety of char products. FIGS. 2a and 2b show distinct losses of weight of a cellulose-based sample during the preparation of an activated carbon.

The first and major weight loss occurs at temperatures less than 220 C e.g. between 140 to 180 C (observed a peak loss at 175 C for materials tested) and is believed to be associated mainly with dehydration of the cellulose precursor (i.e. loss of water from the chemical structure of the precursor). It is believed that this reaction may be advantageously conducted in the presence of a dehydrating agent such as phosphoric acid or pyrophosphoric acid which may increase the rate of dehydration (see FIG. 16). A relatively long heating period at the dehydration stage will favour more time for dehydration to occur (e.g. a 24 hour or longer heating period may for example be advantageous although depending on process conditions a shorter period may be used). It is believed that this approach favours dehydration to near completion before the onset of undesirable bond cleavage which occurs at higher temperature. It is believed that increased dehydration tends to increased char yields and the dehydration mechanisms may be the most important in the pyrolysis of materials such as cellulose and the like as described herein.

FIGS. 3 and 4 show the effect of the concentration of the dehydrating agent phosphoric acid added to cotton and viscose rayon respectively on the yield of low temperature char.

Theoretical yield (67%) occurs at 28±2% w/w phosphoric acid impregnation for both precursors.

FIG. 5 demonstrates the effect of charring temperature on the yield of cotton char. These results confirm those obtained thermogravimetrically with this precursor. The advantageous temperature for cotton is 140 C-150 C and 160 C-170 C for viscose rayon.

The Low Temperature Char prepared in this manner may have a yield which approaches theoretical that is 66.7% of the original sample's weight. It is believed that it is most likely a 5,6-cellulosic derivative.

The second loss of weight occurs at temperatures below 450 C e.g. between 250 C to 400 C (observed peak between 350 to 380 C for tested materials) and is believed most likely associated with the loss of carbon dioxide by each cellulosene thus fragmenting the original carbon structure to building blocks suitable for recombination to a graphitene-like structure. It is believed that these building blocks probably contain only five carbons derived from the cellulosene derivative during bond cleavage and the thermal depolymerisation of the original cellulosic molecule. Several compounds such as phosphoric acid, pyrophosphoric acid, boric acid, ammonium borate, ammonium chloride, ammonium phosphate, potassium hydroxide and many others may participate, either individually or in combination in the depolymerization and recombination reactions and the subsequent formation of pores. A predetermined selection of carbonization reagent(s) may be made so as to ensure the optimal porosity of the Medium Temperature Char. It is believed that carbonisation may be virtually complete by 450 C and it is believed that the carbon content of the char may attain 85% or more. It is also believed that volatile matter, that is, tarry material and decomposition products and carbon from their thermal breakdown formed during this process may possibly be deposited in the pores and contribute to the predominantly microporous nature of this char. FIG. 6 shows the effect of a 10 minute duration heating period on the adsorptive capacity of a Medium Temperature Char obtained from a viscose rayon Low Temperature Char (used “as is”) to which an additional 30-37% w/w phosphoric acid had been nominally added (i.e. impregnated). The Low Temperature Char had been obtained using the conditions discussed earlier to maximize its yield (25-30% phosphoric acid w/w; 150.3±5.7 C). It should be noted that (with respect to the aromatisation and reformation stages), heating periods longer than 10 minutes at the charring temperature may result in progressively lower adsorptive capacities (for a flow through heater) unless means are taken to replenish the phosphoric acid loss through volatilization. It is obvious from FIG. 6 that a charring temperature of 340 C-380 C allows for the achievement of a BET (surface area) of 1700 m²/gm or more. FIG. 7 illustrates the effect of the amount of phosphoric acid added to the Low Temperature Char used “as is” on the adsorptive capacity of the Medium Temperature Char. These tests were conducted at 358 C-376 C for a 10 minute duration. According to the results of these tests, an advantageous concentration of acid may be 30-40% and preferably 35% for the material tested.

The amount of phosphoric acid added to the Low Temperature Char had an effect on the yield of Medium Temperature Char as demonstrated by FIG. 8. The average yield obtained for 15 separate tests conducted at 332.0 C-396.2 C with Low Temperature Chars (prepared at 150.3±5.7 C from viscose rayon impregnated with 25-30% w/w phosphoric acid) to which varying amounts of phosphoric acid had been added was 34.1±2.7% and ranged from 29.5-38.4%. Generally, yields increased with the amount of phosphoric acid added to the Low Temperature Char and optimal yields are obtained when 35% w/w or more acid is added. The estimated theoretical yield of Medium Temperature Char is evaluated at 40%.

The pore volume distribution of a typical Medium Temperature Char is shown in FIG. 9. It clearly demonstrates the microporous nature of this char with pore size predominantly <20 Å. A comparison of the pore distribution for a typical Medium Temperature Char(B83BMTC1 1669 m²/g) with that of a commercial activated carbon felt (ACF-1381 m²/g) and activated granular carbon (AGC-908 m²/g) prepared by an activation by gasification process is shown in FIG. 10. It clearly demonstrates the advantageous porosity of the char reported herein. The mean total pore volume for ten samples of Medium Temperature Char having an average (BET) of 1506±72 ml/gm is 0.783±0.04 cc/gm and the micropore volume is 0.571±0.06 cc/gm (Alpha-s data). The Langmuir plot confirms that a modest area associated with mesopores does exist. However, macropores appear to be absent. A comparison of the capacity to absorb toluene vapours between the Medium Temperature Char (MTC) and a activated carbon granules (AGC) of lower density prepared by the more energy costly and destructive gasification process is shown in Table 1.

TABLE 1
Comparison of Adsorptive Capacity for Toluene

| | | | | Adsorptive |
|---|---|---|---|---|
| Sample | Relative | Flowrate | BET | Capacity |
| Description | Humidity (%) | (cc/min) | (m²/gm) | (mg/gm) |
| MTC | 73 | 99.4 | 1579 | 140.8 |
| MTC | 53 | 108 | 1425 | 262.7 |
| AGC | 45 | 117 | 1250 | 237.3 |

The third and lesser loss of weight occurs at a temperature of up to 650 C e.g. between 500 and 600 C (FIG. 2b) and is believed to correspond to a loss of hydrogen due to the development of the aromatic structure and the loss of the ether linkages and possibly the continuing release of pyrolysis products formed at lower temperatures and located in the char's pores. During this phase, it is believed that the fragments rearrange spatially from the precursor structure to an aromatic graphitene structure. This thermal rearrangement is accompanied by a significant shrinkage of the low temperature char which plays a vital role in the development of porosity in the char. It is believed that olefinic bonds and aromatic structures predominate in this char and are probably responsible for its relatively lower electrical resistivity (kilo Ohms-cm).

At temperatures >600 C, the known usual approach is to activate the char by exposure to gasifying agents such as CO₂ or steam at elevated temperatures, usually 800-900 C. This procedure is called Activation by Gasification and it is by far the most popular. It should be noted that this procedure is invariably accompanied by significant loss of carbon and char yields diminish precipitously with increasing adsorptive capacity, usually not exceeding 20% at BETs>1600 m²/gm. The overall procedure described herein in accordance with the present invention is a Chemical Activation. Thus a high temperature char may be advantageously subjected to a further Chemical Activation at temperatures >650 C.

The resistivity of such an elevated temperature char may also drop to <100 Ohms-cm. It is believed that this is most probably due to the fact that the carbon layer planes have achieved even greater planarity.

FIG. 11 illustrates the impact of charring temperature on the adsorptive capacity of the high and elevated temperature chars prepared using a similar estimated phosphoric acid content and heat treatment time. It is evident that the high values are obtained at temperatures >750° C. Tests using temperatures >850° C. have yielded activated chars with adsorptive capacities >2300 m²/gm. FIG. 12 demonstrates the effect of estimated phosphoric acid content on BET (all chars prepared using similar conditions). Note that, in the absence of phosphoric acid added to the medium temperature char, the adsorptive capacity is <600 m²/gm. Char yields are generally higher at elevated phosphoric acid content. Char yields averaged 29.6±4.5% under similar preparation conditions. The estimated theoretical yield is 38.3%. Yields approaching theoretical have been obtained for chars prepared directly from the Low Temperature Char. The Bulk Density of the final product again approximates that of the precursor and averages 0.15 gm/cc.

The pore volume distribution of a typical Elevated Temperature Char is shown in FIG. 13. A comparison with the pore distribution for a Medium Temperature Char shown in FIG. 9 reveals a dramatic difference in porosity between these two types of products. There is a clear shift in porosity to larger pore sizes. Pores in the 15-18 Å range predominate and pores in the 20 to 28 Å range distinctly gain in population. In fact, this char could be said to be significantly less microporous (<20 Å) than its predecessor the Medium Temperature Char. This apparently only occurs at temperatures >650 C in the presence of a chemical reagent with the physical and chemical properties of material such as phosphoric acid. A comparison of the pore volume distribution of the Elevated Temperature Char (B99AETC-2229 m²/g) with that of representative commercial activated carbon granules (AGC-903 m²/g), felt (ACF-1381 m²/g) and powder (ACP-2928m²/g) is given in FIG. 14. (Note that the activated carbon powder selected MAXSORB is one of the most highly adsorptive product available). It clearly shows the distinctive porosity of the Elevated Temperature Char-one that favours larger size pores. The Mean Total Pore Volume for ten representative samples of High Temperature Char having an average (BET) of 1974±111 m²/gm is 0.980±0.06 cc/gm and the Micropore Volume is 0.752±0.05 cc/gm Alpha-s data). The Langmuir plots for these samples clearly illustrates a growing population for mesopores.

A comparison of the Pore Distribution Profiles for the Medium Temperature Char (FIG. 9) and that for the Elevated Temperature Char (FIG. 13) and that for the High Temperature Char (FIG. 15) and that of many intermediate chars prepared at temperatures ranging between 500 to 800 C (not shown) reveals that it is possible to tailor the porosity of any given char to any value required by a specific need by a careful selection of the char preparation conditions for the various phases or stages described herein (table 3).

Table 2 shows the association between a greater capability to adsorb organic vapours such as carbon tetrachloride (CTC) and toluene and the distinctive porosity of the High Temperature Char (HTC) and Elevated Temperature Char (ETC) as compared to a representative

TABLE 2
Adsorptive capacity for organic vapours

| | Relative | | | Adsorptive | Capacity |
|---|---|---|---|---|---|
| Sample | Humidity | Flowrate | BET | Toluene | CTC |
| Description | (%) | (cc/min) | (m²/gm) | (mg/gm) | (mg/gm) |
| HTC | 58 | 107 | 1557 | 361.2 | 252.3 |
| ETC | 73.5 | 107 | 1918 | 524 | |
| ACG | 51 | 98 | 1250 | 257.6 | |

activated carbon granules sample (ACG-commercial) for both organic vapours obtained under similar conditions. The Elevated Temperature Char is clearly the best sorbent for these organic vapours.

For the following tables 3 and 4 the activated carbon materials were based on viscose rayon.

TABLE 3
Pore Volume Distributions for Specific Ranges of Pore Sizes
Percent of Total Pore Volume (%)

| Char | | | | | | |
|---|---|---|---|---|---|---|
| Type | 4-10 Å | 10-20 Å | 4-20 Å | 20-30 Å | >10 Å | >20 Å |
| Medium Temperature | 55.7 ± 2.4 | 36.8 ± 1.1 | 93.3 ± 1.1 | 3.1 ± 1.6 | 43.2 ± 1.3 | 6.8 ± 1.8 |
| High Temperature | 45.4 ± 4.7 | 37.8 ± 1.3 | 83.1 ± 5.8 | 14.4 ± 5.4 | 54.6 ± 4.7 | 17.1 ± 5.4 |
| Elevated Temperature | 18.1 ± 1.2 | 49.6 ± 5.1 | 68.4 ± 4.6 | 26.8 ± 2.8 | 82.4 ± 0.8 | 31.5 ± 4.4 |

Note:
Calculations based on Density Functional Theory data obtained from at least ten chars per type

TABLE 4
Estimated Mesopore Area as Percentage of Total Pore Area

| | BET | Mesopore Area | Fraction of |
|---|---|---|---|
| Char Type | (m²/gm) | (m²/gm) | Total Area (%) |
| Medium Temperature | 1416 ± 113 | 44.5 ± 15 | 3.2 ± 0.5 |
| High Temperature | 1600 ± 82 | 95.1 ± 37 | 5.8 ± 2.1 |
| Elevated Temperature | 1930 ± 180 | 196.8 ± 70 | 11.5 ± 3.6 |

Based on DFT data obtained from more than 10 char samples per type

1.-215. (canceled)

92. A process for the preparation of an activated carbonized material, comprising subjecting a starting dehydrated carbon precursor material to a carbonization stage whereby carbon is lost from the structure of the starting dehydrated carbon precursor material,
wherein
the carbonization stage comprises
a carbonization heating step comprising heating the starting dehydrated carbon precursor material, in the presence of a carbonization stage treatment agent, at a carbonization temperature below 450° C. for a time period sufficient so as to obtain an activated carbonized material
wherein the starting dehydrated carbon precursor material has been obtained from a process for the preparation of a dehydrated carbon precursor material from a starting carbon precursor material, said starting carbon precursor material being a cellulosic material, comprising subjecting said cellulosic material to a dehydration stage whereby water is eliminated from the structure of the cellulosic material,
wherein
the dehydration stage comprises
a dehydration heating step comprising heating the cellulosic material, in the presence of a dehydration stage treatment agent, at a dehydration temperature below 220° C. for a time period sufficient so as to obtain a dehydrated carbon precursor material
and wherein the respective treatment agent of said dehydration stage and said carbonization stage each independently consists of a member selected from the group consisting of polar solvent soluble phosphorous containing inorganic lewis acid compounds and mixtures thereof.

93. A process as defined in claim 92 wherein the carbonization heating step comprises heating said dehydrated carbon precursor material at a temperature in the range of from 250° C. to 400° C. and wherein said dehydration heating step comprises heating said cellulosic material at a temperature in the range of from 120° C. to 200° C.

94. A process as defined in claim 92 wherein said dehydration stage treatment agent and said carbonization stage treatment agent each independently comprises a member selected from the group consisting of phosphoric acid, polyphosphoric acid, pyrophosphoric acid, metaphosphoric acid and mixtures thereof.

95. A process as defined in claim 94 wherein said cellulosic material and said dehydrated carbon precursor material are each impregnated with a respective treatment agent.

96. A process as defined in claim 95 comprising a polar solvent washing step wherein carbonization stage treatment agent associated with said activated carbonized material is washed from said activated carbonized material with a polar solvent.

97. A process as defined in claim 92 further comprising subjecting said activated carbonized material to an activation stage to obtain an activated carbon product,
wherein
the activation stage comprises
a subsequent activation heating step comprising heating said activated carbonized precursor material in the presence of an oxidation-suppressing atmosphere, in the presence of a activation stage treatment agent at an activation temperature higher than 650° C. for a time period sufficient so as to obtain an activated carbon product,
and wherein the treatment agent of said activation stage independently consists of a member selected from the group consisting of polar solvent soluble phosphorous containing inorganic lewis acid compounds and mixtures thereof

98. A process as defined in claim 97 wherein said dehydration heating step comprises heating said cellulosic material at a temperature in the range of from 120° C. to 200° C., wherein said carbonization heating step comprises heating said dehydrated carbon precursor material at a temperature in the range of from 220° C. to 400° C., and wherein said subsequent activation heating step comprises heating said activated carbonized precursor material at a temperature in the range of from 700° C. to 1200° C.

99. A process as defined in claim 98 wherein said dehydration stage treatment agent, said carbonization stage treatment agent and said activation stage treatment agent each independently comprises a member selected from the group consisting of phosphoric acid, polyphosphoric acid, pyrophosphoric acid, metaphosphoric acid and mixtures thereof.

100. A process as defined in claim 97 wherein said dehydration stage treatment agent, said carbonization stage treatment agent and said activation stage treatment agent each independently comprises a member selected from the group consisting of phosphoric acid, polyphosphoric acid, pyrophosphoric acid, metaphosphoric acid and mixtures thereof.

101. A process as defined in claim 97 wherein
said dehydration stage comprises
prior to said dehydration heating step an impregnation step wherein said cellulosic material is associated with a dehydration stage treatment agent as to obtain cellulosic material impregnated with dehydration stage treatment agent.

102. A process as defined in claim 101 wherein
said dehydration stage comprises
subsequent to said dehydration heating step a polar solvent washing step wherein dehydration stage treatment agent is washed from said dehydrated carbon precursor material.

103. A process as defined in claim 97 wherein
said carbonization stage comprises
prior to said carbonization heating step an impregnation step wherein said dehydrated carbon precursor material is associated with an carbonization stage treatment agent so as to obtain dehydrated carbon precursor material impregnated with carbonization stage treatment agent.

104. A process as defined in claim 103 wherein
said carbonization stage comprises
subsequent to said carbonization heating step a polar solvent washing step wherein carbonization stage treatment agent is washed from said carbonized precursor material.

105. A process as defined in claim 97 wherein
said activation stage comprises
prior to said subsequent activation heating step an impregnation step wherein said obtained carbonized precursor material is associated with an activation stage treatment agent so as to obtain a carbonized precursor material impregnated with activation stage treatment agent.

106. A process as defined in claim 105 wherein
said activation stage comprises
subsequent to said activation heating step a polar solvent washing step wherein activation stage treatment agent is washed from said activated carbon product.

107. A process as defined in claim 97 wherein for said activation stage, said activated carbonized precursor material is a gas flowthrough porous material and said heating thereof occurs in the presence of an oxidation-suppressing atmosphere comprising an oxidation-suppressing gas, said gas being induced to flow through said activated carbonized precursor material, and wherein a source of activation stage treatment agent is disposed upstream of said activated carbonized precursor material for introducing volatized activation stage treatment agent into said gas flow, said activation stage treatment agent having a volatilization temperature below the treatment temperature used for obtaining said activated carbon product.

108. A process as defined in claim 98 wherein for said activation stage, said activated carbonized precursor material is a gas flowthrough porous material and said heating thereof occurs in the presence of an oxidation-suppressing atmosphere comprising an oxidation-suppressing gas, said gas being induced to flow through said activated carbonized precursor material, and wherein a source of activation stage treatment agent is disposed upstream of said activated carbonized precursor material for introducing volatized activation stage treatment agent into said gas flow, said activation stage treatment agent having a volatilization temperature below the treatment temperature used for obtaining said activated carbon product.

109. An activated carbon material derived from a cellulosic material and having a resistivity in the range of 2 to 1000 Ohms-cm.

110. An activated carbon material as defined in claim 109 having a resistivity of not more than 550 Ohms-cm.

111. An activated carbon material as defined in claim 109 having a resistivity of not more than 55 Ohms-cm.

112. An activated carbon material derived from a cellulosic material characterized in that at least 10% of the total pore volume of the activated carbon material is attributable to pores having a pore size of 20 angstroms or higher.

113. An activated carbon material as defined in claim 112 characterized in that at least 12% of the total pore volume of the activated carbon material is attributable to pores having a pore size of 20 angstroms or higher.

114. An activated carbon material as defined in claim 112 characterized in that at least 15% of the total pore volume of the activated carbon material is attributable to pores having a pore size of 20 angstroms or higher.

115. An activated carbon material as defined in claim 112 characterized in that at least 20% of the total pore volume of the activated carbon material is attributable to pores having a pore size of 20 angstroms or higher.

116. An activated carbon material derived as defined in claim 112 wherein at least 45% of the total pore volume of the activated carbon material is attributable to pores having a pore size of 10 angstroms or higher.

117. An activated carbon material as defined in claim 116 characterized in that at least 12% of the total pore volume of the activated carbon material is attributable to pores having a pore size of 20 angstroms or higher and in that at least 50% of the total pore volume of the activated carbon material is attributable to pores having a pore size of 10 angstroms or higher.

118. An activated carbon material as defined in claim 116 characterized in that at least 15% of the total pore volume of the activated carbon material is attributable to pores having a pore size of 20 angstroms or higher and in that at least 50% of the total pore volume of the activated carbon material is attributable to pores having a pore size of 10 angstroms or higher.

119. An activated carbon material as defined in claim 116 characterized in that at least 20% of the total pore volume of the activated carbon material is attributable to pores having a pore size of 20 angstroms or higher and in that at least 60% of the total pore volume of the activated carbon material is attributable to pores having a pore size of 10 angstroms or higher.

120. An activated carbon material as defined in claim 119 having a resistivity in the range of 2 to 1000 Ohms-cm.

121. An activated carbon material as defined in claim 112 having a resistivity in the range of 2 to 1000 Ohms-cm.
